(19) United States
(12) Patent Application Publication
(10) Pub. No.: US 2014/0081672 A1
(43) Pub. Date: Mar. 20, 2014

(54) Collateralized Cash Clearing System and Method

(71) Applicant: Samir Chawla, Toronto (CA)

(72) Inventor: Samir Chawla, Toronto (CA)

(21) Appl. No.: 14/028,220

(22) Filed: Sep. 16, 2013

Related U.S. Application Data
(60) Provisional application No. 61/702,148, filed on Sep. 17, 2012.

(51) Int. Cl. G06Q 40/08

(52) U.S. Cl. CPC G06Q 40/08
USPC 705/4

(57) ABSTRACT

Computer-implemented methods and systems are provided for fulfilling obligations between a plurality of parties over a computer network. In an exemplary implementation, a computer implemented method for fulfilling obligations between a plurality of parties over a computer network is provided. In this exemplary implementation, on a client controlled by a first party of the plurality of parties, a party can initiate a payment transaction request, in a single currency, to a second party of the plurality of parties. The payment transaction request is then sent to a server controlled by an independent third party to the plurality of parties. The server then accepts payment transaction requests from the client machine and saves the transactions as uncleared incoming and outgoing payment transactions in a data store. At a time determined by the server, all uncleared payment transactions from the plurality of parties are cleared.

### CROSS-REFERENCE TO RELATED APPLICATIONS

This application claims priority from U.S. Application No. 61/702,148 filed on Sep. 17, 2012, the disclosure of which is incorporated herein by reference in their entirety.

### TECHNICAL FIELD

The present disclosure generally relates to fulfilling obligations between parties.

### BACKGROUND

Transactions through the SWIFT network for cross currency trades typically go through the central bank of the currency used in the transaction. For example, a payment instruction issued through the SWIFT network for a payment in Mexican Pesos will go through the Mexican Central Bank if the instruction originates from a US-based bank.

These transactions, however, cannot be completed if the currency's central bank is closed. If the settlement of a cross currency trade occurs during a time of the day when that respective currency cannot be paid, the payor must wait until the currency's central bank reopens.

In other situations, transactions may fail to complete if there is insufficient quantity of a specific currency to settle a cross currency transaction.

In scenarios such as the ones described above, risk is introduced to the transaction that must either be borne by the payor or the receiver party. In extreme circumstances such as natural disasters, economic collapse, or national collapse, this may trigger a domino effect of failed trades, putting both the parties at risk.

### SUMMARY

What is provided are systems and computer-implemented methods for fulfilling cross currency obligations between a plurality of parties over a computer network, the obligations guaranteed by the independent third party. By decoupling the fulfillment of cross-border transactions from the operating hours of each currency's central bank, risks to the parties and to the financial system can be reduced. Furthermore, by requiring that party's deposit sufficient collateral to cover their payment transactions, payments can be guaranteed. That is, the collateral can be liquidated if the party is unable to fulfill its obligation. This allows the payment transaction to be fulfilled regardless of the condition of the payor party.

In one aspect, a Collateralized Cash Clearing System (CCCS) is provided. This system guarantees and fulfills cross currency obligations between parties at any time of the day. In an exemplary implementation, the system comprises a data store configured to store transactional, client, and system data. The system also has a server that has one or more data processors. The data processors are configured to process payment transactions in one or more currencies from one or more clients, apply risk management filters to the payment transaction, store the payment transactions in the data store as incoming and outgoing pending payment transactions, clear the transactions at a set time using transaction data stored in the data store by offsetting each party's incoming and outgoing payment transactions for each currency so that each party has a net positive or net negative balance for each currency; provide status reports to clients on demand; notify clients of a deposit requirement when the client has a net negative balance; and liquidate at least a portion of the client's collateral to cover the deposit requirement if the deposit requirement is not completed before a timer expires. The system also has one or more clients configured to initiate payment transaction requests and to requests status reports from the server.

A CCCS is an interbank payment clearing system accessible via an online and secure network that is used by banks and other financial institutions, called clearing members. A CCCS clears clearing member to clearing member cash payments of the various currencies that have been approved by the system. Cash payments are guaranteed and honored by a CCCS by requiring all clearing members to deposit collateral in their clearing accounts that secure the value of their outgoing payments. On a set schedule, the system is “cleared” meaning that the monies of all currencies are to be paid/received on the system are netted together and physically paid in and out to clearing members. After the settlement process, all money that has been physically paid/received nets to a balance of zero. If a clearing member were to default on an obligation to pay during the settlement process their collateral would be liquidated and converted to the payments that were defaulted then paid out to the receiving clearing member(s). There would also be penalties and/or legal action against a clearing member who defaults during a settlement process.

In another aspect, computer-implemented methods are provided for fulfilling obligations between a plurality of parties over a computer network. In an exemplary implementation, a client that is controlled by a first party of the plurality of parties is provided. The party can use the client to initiate a payment transaction request, in a single currency, to a second party of the plurality of parties. This payment transaction request is then sent to a server that is controlled by an independent third party. The payment transaction request is accepted by the server. The server converts the first party's payment transaction to the first party's base currency. The server then determines whether the first party has sufficient margin balance to cover the payment transaction request. The server does this by determining whether the payment transaction request will cause the first party's margin balance to fall below a threshold value. Once approved, this transaction is stored as an uncleared outgoing payment transaction for the first party and as an uncleared incoming payment transaction for the second party in the data store. At a time determined by the server, any uncleared payment transactions are cleared. The clearing process involves offsetting each party's outgoing and incoming payment transactions for each currency so that each party has a net positive or net negative margin balance for each currency. Those parties with a negative margin balance must deposit the negative margin balance before a predetermined time frame set by the server. Furthermore, the net of all uncleared incoming and outgoing payment transactions for all parties is zero. The margin balance is determined by adding a total collateral value of the party with the total incoming payment transaction value for the party in all currencies, converted to the party's base currency, and subtracting the total outgoing payment transaction value for the party in all currencies, converted to the party's base currency. If a party having a negative margin balance fails to deposit the balance within the predetermined time frame, the party's collateral is liquidated to cover the net negative balance.

In another exemplary implementation, the pool of transactions for all parties is netted before transactions are fulfilled. This allows for transactions to offset, reducing the overall currency transfer requirement and mitigating risk for the system. This exemplary implementation also allows parties to engage in financial transactions at any time of the day.

In another aspect, a computer implemented method for fulfilling obligations between a plurality of parties over a computer network is provided. In this exemplary implementation, on a client controlled by a first party of the plurality of parties, a party can initiate a payment transaction request, in a single currency, to a second party of the plurality of parties. The payment transaction request is then sent to a server controlled by an independent third party to the plurality of parties. The server then accepts payment transaction requests from the client machine and saves the transactions as uncleared incoming and outgoing payment transactions in a data store. At a time determined by the server, all uncleared payment transactions from the plurality of parties are cleared.

In another aspect, a system for fulfilling obligations between a plurality of parties over a computer network is provided. The system comprises a data store configured to store transactional, client, and system data. The system also comprises at least one server configured to process payment transactions in one or more currencies from one or more clients; store the payment transactions in the data store as incoming and outgoing pending payment transactions; and clear the transactions at a set time using transaction data stored in the data store by offsetting each party's incoming and outgoing payment transactions for each currency so that each party has a net positive or net negative balance for each currency. The system also comprises one or more clients configured to initiate payment transaction requests.

In yet another aspect, a computer implemented method for fulfilling cross-currency payment obligations between a plurality of parties over a computer network is provided. In this exemplary implementation, on a client controlled by a first party of the plurality of parties, a party can initiate a payment transaction request, in a single currency, to a second party of the plurality of parties. The payment transaction request is then sent to a server controlled by an independent third party to the plurality of parties. The server then accepts payment transaction requests from the client machine and saves the transactions as uncleared incoming and outgoing payment transactions in a data store. At a time determined by the server, all uncleared payment transactions from the plurality of parties are cleared.

### DESCRIPTION OF THE DRAWINGS

FIG. 1 is a system diagram of an exemplary implementation Collateralized Cash Clearing System (CCCS).

FIGS. 2 to 3 are flowcharts illustrating exemplary implementations of the clearing process.

FIGS. 4 and 5 are flowcharts illustrating an exemplary implementation of the collateral deposit and transaction approval process.

FIGS. 6 and 7 are flowcharts illustrating an exemplary implementation of the payment order and payment order transaction approval process.

FIG. 8 is a flowchart illustrating an exemplary implementation of the margin balance update process.

FIGS. 9 to 29 show an exemplary implementation client interface as shown on a client machine for the Collateralized Cash Clearing System (CCCS).

FIGS. 30 to 48 show an exemplary implementation system administrator interface as shown on a client machine for the Collateralized Cash Clearing System (CCCS).

FIG. 49 shows an exemplary implementation generic computer device.

### DETAILED DESCRIPTION

The systems and methods provided allow parties to fulfill obligations through an independent third party that guarantees that the cross currency obligations will be fulfilled. In an exemplary implementation, the CCCS guarantees and fulfills cross currency obligations. An exemplary implementation of how the CCCS is used is described in the simple scenario between two CCCS member parties provided below.

The following definitions apply to the description.

Asset: A liquid security acceptable by a CCCS to be deposited by a clearing member via a securities depository to a CCCS in their clearing account and that has margin value.

Approved Currency: A currency that has been approved by a CCCS to allow guaranteed payments amongst its clearing members and to settle during its settlement process.

Base Currency: The currency rate on a CCCS that a party can adjust which reflects the displayed margin figures of an aforementioned reference. That is, the member party's default currency

Clearing Member: A bank, a broker, or a financial institution that has applied, been vetted and been approved to conduct transactions on a CCCS by the CCCS.

Clearing Account: A clearing member's account with a CCCS.

Clearing Balances: The balance of funds a clearing member will pay (negative clearing balance) and receive (positive clearing balance) for each applicable approved currency during the settlement process.

Clearing Window: An identifiable singular channel of a CCCS that is pre-set to have its settlement process at a certain time. Multiple clearing windows can exist with different times that the settlement process is run. Each clearing window is margined separately.

Collateral: A broad term that is a reference to Assets, Hard Cash, Soft Cash, Security or Commodity redeemable for value by a Collateralized Cash Clearing System in partial or by whole, individually or combined that has margin value in and by a CCCS.

Hard Cash: Physical cash deposited to a CCCS by a clearing member that is held in their clearing account and has margin value. Soft Cash: Incoming guaranteed payments that are held in a clearing member's clearing account and has margin value. Soft cash is calculated by summing the value of a clearing member's positive clearing balances in the party's base currency.

Guaranteed Payment: A transferable guarantee that a payment in an approved currency will be honored by the CCCS during its settlement process. It is instructed in the CCCS by a clearing member to guarantee a payment to another clearing member. The CCCS takes custody of the paying clearing member's collateral in order to honour the guaranteed payments in case of default. Therefore a guaranteed payment is not a physical or official exchange of any monies.

Margin Requirement: The margin value of all outgoing guaranteed payments in all approved currencies added together in the party's base currency. Margin requirements are calculated by summing the value of a clearing member's negative clearing balances and displaying it in the party's base currency.

Margin Balance: The value representing a clearing member's total margin value minus the margin requirement as valued by a CCCS in the party's base currency.

Margin Value: The total value of a party's hard cash, soft cash, and asset collateral minus any conversion, or risk management adjustments, in the party's base currency.

Party: An approved member of the CCCS that is either a payor or receiver of the proceeds of a transaction.

Settlement Process: The moment in time or times (determined by a CCCS) when guaranteed payments are honored by the CCCS. The CCCS may net all payments occurring in this window to streamline payment. All clearing members pay off all negative clearing balances and receive their positive clearing balances from a CCCS neutralizing all clearing balances, margin requirements and soft cash.

System Administrator: An employee, officer, authorized personnel or virtual/automated entity internal or external of a CCCS that has administrative access to a CCCS.

User: Any system administrator or authorized personnel of a clearing member that has access to the CCCS.

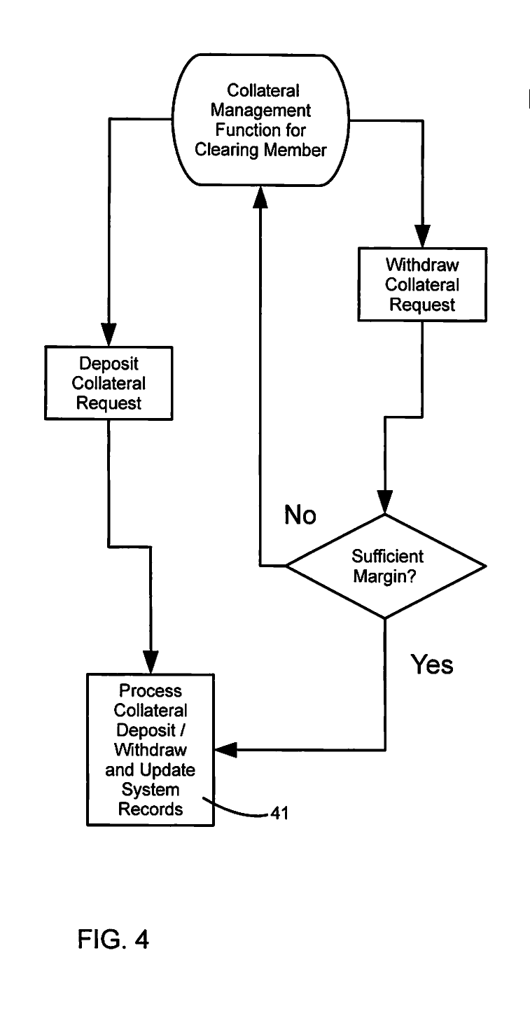

First, the payor party deposits collateral with the CCCS. An exemplary implementation of how the CCCS might handle a collateral withdrawal or deposit transaction is provided in FIG. 4. In this exemplary implementation, collateral may be any combination of cash, soft cash, or any approved security, government debt, or bond. Generally, easily liquidated assets are preferred as collateral. This collateral is used to protect the CCCS by ensuring that sufficient funds will be available if the payor party fails to meet their margin deposit obligations. As will be discussed later, if the payor parties fails to meet their margin deposit obligations, the collateral is liquidated and used to cover the outstanding negative clearing balance.

The transaction is then processed by the system 41. The step of processing can include adjusting the collateral deposit amount to account for variables such as, but not limited to, risk, currency conversion, or regulations. For example, if the collateral is not in the payor party's specified base currency, then the value of the collateral will be converted to be in the base currency. This deposited amount, subject to adjustments during processing 41, represents the party's margin balance. The CCCS's records are then updated with the transaction data.

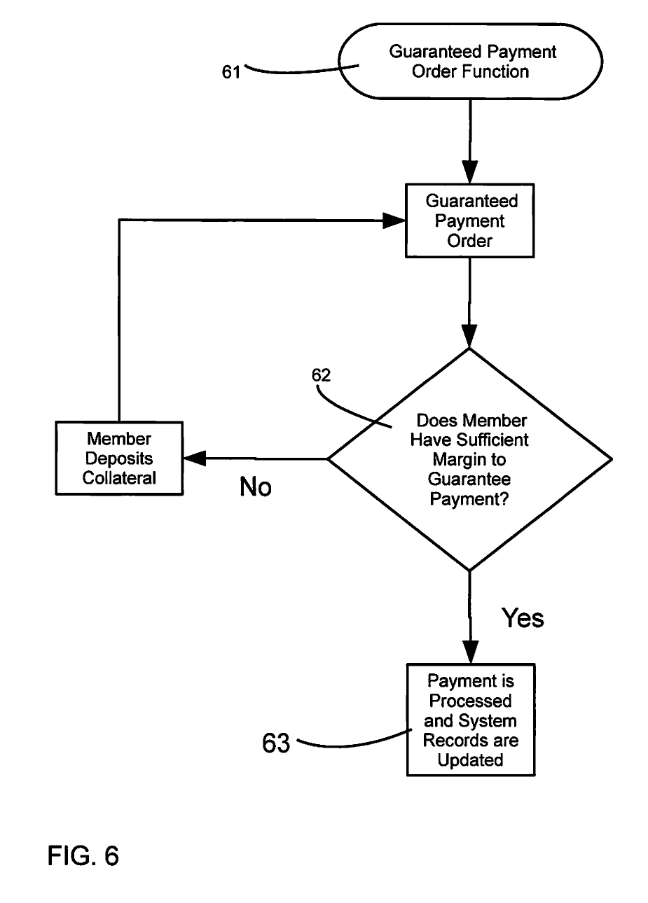

In an exemplary implementation shown in FIG. 6, the payor party can then initiate a payment transaction 61 to a receiver party of an amount up to, but not exceeding, the value of the margin balance. In this exemplary implementation, the CCCS will check to ensure that the payor party has sufficient margin to guarantee payment 62.

In some exemplary implementations, the payment transaction can be in any one of a CCCS-approved basket of currencies regardless of the currency of the collateral on deposit. In this exemplary implementation the CCCS will convert the transaction amount to the payor party's base currency when determining whether the payor party has sufficient margin to guarantee payment 62.

When the CCCS has determined that the payor party has sufficient collateral to complete the transaction the CCCS processes the transaction 63. During processing, the outgoing payment transaction amount is deducted from the payor party's clearing balance in the particular currency of the transaction. The payor's margin balance is also updated to reflect the payment transaction amount, converted to the payor's base currency.

In some exemplary implementations, during processing this outgoing payment transaction is paired with an incoming payment transaction, or receipt transaction, to the receiver party. This receipt transaction may be automatically generated by the CCCS. This receipt transaction updates the receiver party's clearing balance by adding the payment transaction to the receiver party's clearing balance for that currency. Similarly, the receiver party's margin balance is adjusted by adding the payment transaction amount, in the receiver party's base currency, to the receiver party's margin balance. In some exemplary implementations, this amount may be categorized as “soft cash”, to distinguish it from hard cash or asset margin value. In other exemplary implementations, no distinction may be made The receiver party may then use this margin balance to initiate its own payment transactions that are unrelated to this transaction currently being described.

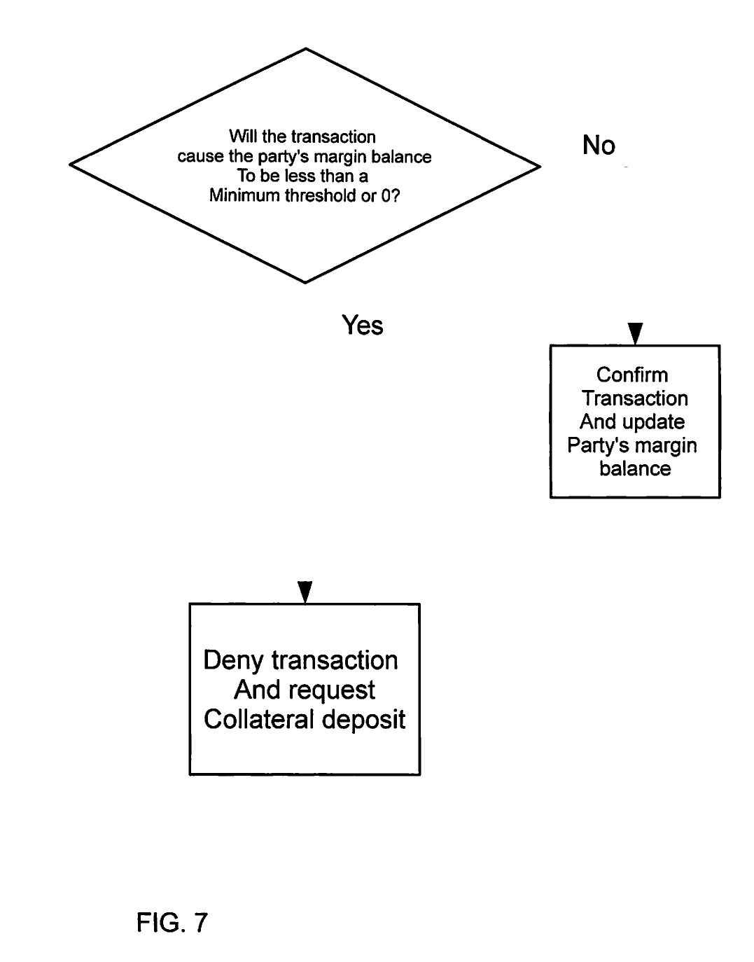

In some exemplary implementations, as shown in FIG. 7, the payment and receipt transactions are not processed until the transactions have been confirmed. That is, the payor and receiver's margin and collateral balances are not updated until the transaction is approved. In some exemplary implementations these transaction requests are automatically processed if the payment criteria complies with defined risk management policies. In other exemplary implementations a system administrator may need to confirm these transactions. In a non-limiting example, the system will approve a payment transaction when it has been determined that the payment transaction will not cause the payor party's margin balance to become negative. Other conditions may also be used to approve or reject a payment transaction. For instance, a member's history of transaction default, or a payment transaction in an amount not typical for that member may also be grounds for rejecting the transaction.

In another exemplary implementation, payment transactions can be modified by the payor party at any time prior to the beginning of the clearing period. For example, in some circumstances the payor party may wish to edit the amount of the transaction, or to cancel the payment transaction completely. As long as the clearing process has not started, the payor party is free to edit the transaction. If the transaction is modified, the system will need to re-confirm the transaction. A corresponding change is made to the receiving transaction so that the change is reflected in both transactions.

In some exemplary implementations, interest rates are periodically applied to any margin, clearing, or collateral balances. In an exemplary implementation, the accrued interest or interest expenses are applied to the party's margin and or clearing balance. In some exemplary implementations the interest rate is set manually by a system administrator. In other exemplary implementations, the interest rate is obtained from a secure and trusted data source. In those implementations where interest is applied to any collateral or margin balances, the interest rate will affect the party's margin and clearing balance. For example, in the exemplary implementation where interest is applied, the party's margin and clearing balance will be adjusted daily. In an exemplary implementation, interest applied to negative clearing balances will be the same as interest applied to positive clearing balances. This way, all interested collected from negative clearing balances will be applied to positive clearing balances for a net interest of zero (0). In other exemplary implementations the system may levy a transaction or administrative fee so that the net interest is not zero (0).

The frequency at which interest is applied will depend on the implementation of the system. In this exemplary implementation, interest may be applied daily, weekly, monthly, or yearly. A skilled person would understand that other interest calculation windows could be used without departing from the scope of this disclosure.

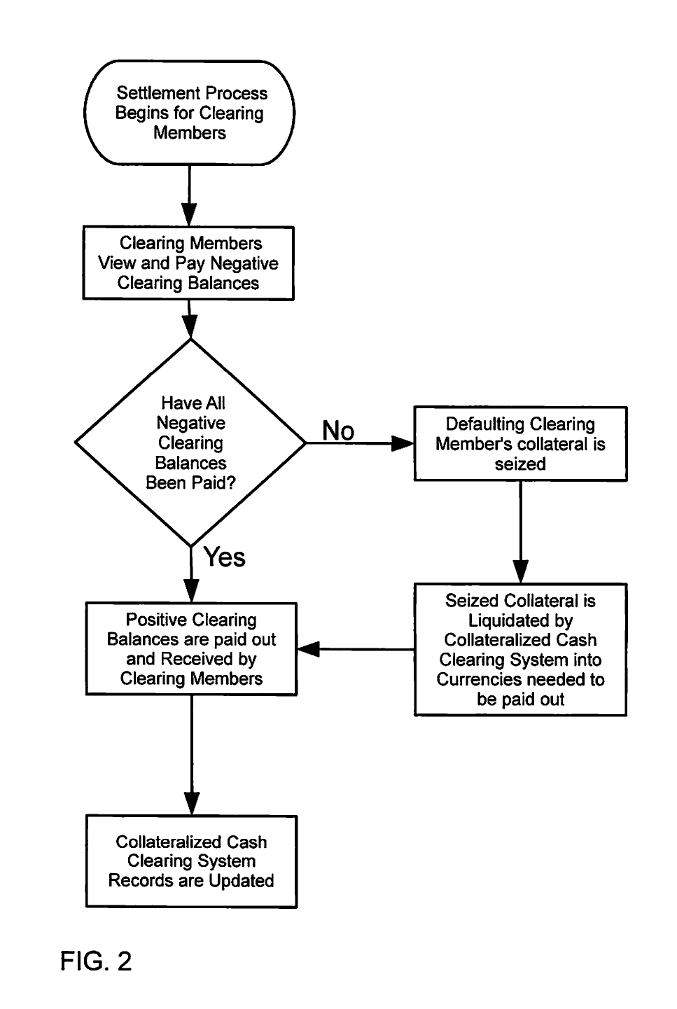

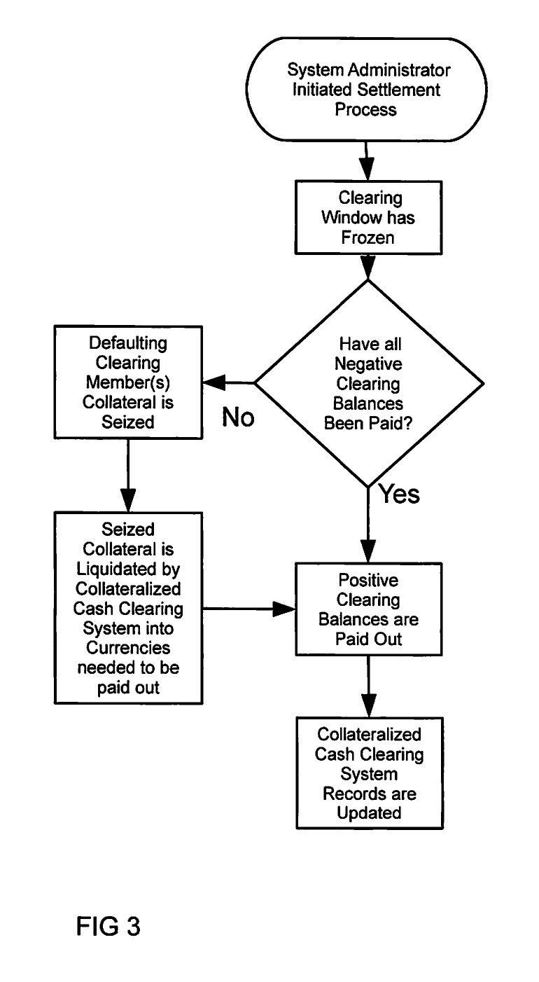

The system then clears the transactions. Exemplary implementations of the clearing process are illustrated in FIGS. 2 and 3. In an exemplary implementation, the clearing process begins at a predetermined time set by the system. In some exemplary implementations, the clearing window may be periodic. That is, clearing windows are regularly scheduled on intervals such as, but not limited to, every minute, every half hour, hourly, every half day, daily, every few days, weekly, every few weeks, monthly, every few months, or yearly. In other exemplary implementations, the system may be configured to allow for clearing windows to be initiated manually so that transactions may be cleared as necessary. In yet another exemplary implementation, a clearing window may be scheduled for a specific time and date.

Once the clearing process has begun the payor party cannot modify existing transactions. During the clearing period the transactions are finalized and obligations are fulfilled. In an exemplary implementation, all paired transactions are committed during the clearing process. In this exemplary implementation, since each payment transaction has an equivalent receipt transaction the net of all paired transactions should be 0. That is, the amount paid by a payor party should equal the amount received by the receiving party such that the net amount of the payor and receiving transactions is zero (0). Thus, at the end of a clearing period, the net balance system-wide for all payment and receipt transactions in all currencies should be zero (0). During the clearing process, the system may modify the payment transaction, the receiving transaction, or both, to adjust the transaction based on market conditions.

In some exemplary implementations, the amount a party pays or receives in a particular transaction may be offset by an amount the party pays or receives in another, unrelated, transaction. For example, in an exemplary implementation a party may be involved in multiple payment transactions with different parties. In some transactions, the party may be a payor. In other transactions, the party may be a receiver. When the clearing process begins, rather than fulfilling each transaction separately, the CCCS may net all of the party's payment and receipt transactions for one or all currencies. For instance, if party A receives $10 USD from party B USD, and party A pays party C $10 USD, the final net clearing amount for party A for all transactions in USD is $0.

In an alternate mixed currency example, positive clearing balances in one currency may be used to offset negative clearing balances in another currency. For instance, if clearing balances for a party are positive $10 USD and negative $11 CAD, the CCCS may convert some or all of the $10 USD to cover the $11 CAD negative clearing balance. In this exemplary implementation, assuming a USD to CAD exchange rate of 1:1.1, the final clearing balance of the party would be $0. This may be used in highly traded currencies such as the USD, CAD, Yen or Euro.

As is shown in FIGS. 2 and 3, in another exemplary implementation, when the clearing process completes, the payor party is requested to deposit the outstanding negative clearing balances for each applicable approved currency, subject to any additional amounts for risk management purposes, to the CCCS so as to cover the payment amount.

If the payor party deposits the outstanding margin amount within the prescribed window, then the payor's margin balance resets to zero (0). If the payor still has collateral in the system, the payor may initiate another payment transaction up to the value of the collateral, subject to any risk management adjustments.

In other exemplary implementations the payor party may be requested to deposit part or all of the transaction amount, in the transaction currency, to the CCCS before the clearing period begins. In some exemplary implementations this may be necessary to ensure that the receiver receives payment immediately after the clearing process completes.

In yet another exemplary implementation, the system may have sufficient currency reserves to fulfill the payment transaction before the payor deposits the full transaction amount in the CCCS. In this exemplary implementation, the CCCS may levy a fee, interest, or penalty on the payor for this service.

As is also shown in FIGS. 2 and 3, if the payor fails to deposit the amount to the CCCS in the allotted time frame, then the payor party is determined to be in default. If the payor party is determined to be in default, the system liquidates the payor party's deposited collateral and uses the proceeds to cover the outstanding margin amount. Amounts may be deducted from the proceeds of the liquidation to pay for penalties, service fees, currency conversion, and risk management.

In this exemplary implementation, during the clearing process the receiving party will receive their positive clearing balance, subject to any amounts deducted for risk management purposes. In some exemplary implementations, the amount will remain in a holding account until the receiver party requests payment. In alternate exemplary implementations, this received amount may be added to the receiving party's collateral so that the receiving party can initiate payment transactions. In other exemplary implementations, the amount can be transferred to a third party bank connected to the system. In yet another exemplary implementation, the amount will be transferred to the clearing member's possession.

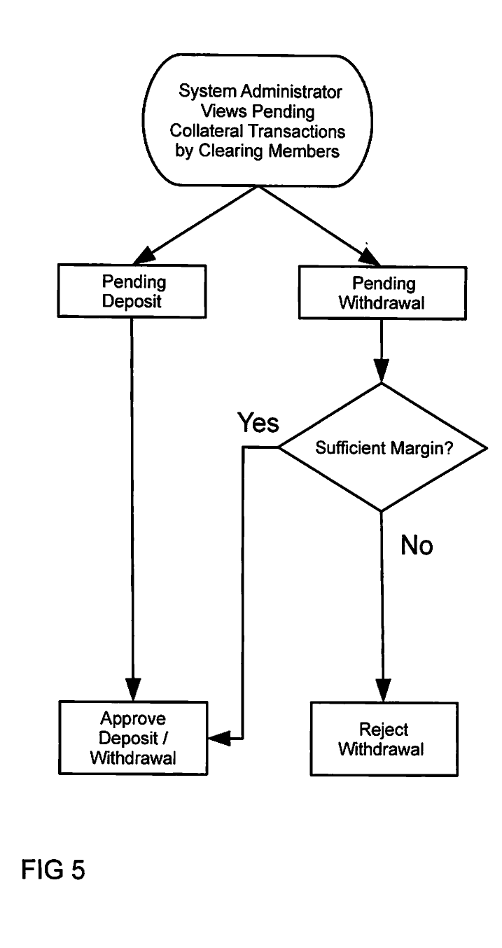

In some exemplary implementations, a collateral withdrawal transaction must be approved by the system before a party can withdraw collateral from the CCCS. In an exemplary implementation shown in FIGS. 4 and 5, any collateral withdrawals are subject to the approval of the CCCS. In some exemplary implementations, the system may automatically approve the transaction if the withdrawal amount does not cause the party's margin balance to become negative. In another exemplary implementation a system administrator of the CCCS may be required to manually review and approve the transaction. In this exemplary implementation, any collateral withdrawal requests that result in a negative margin balance will be rejected.

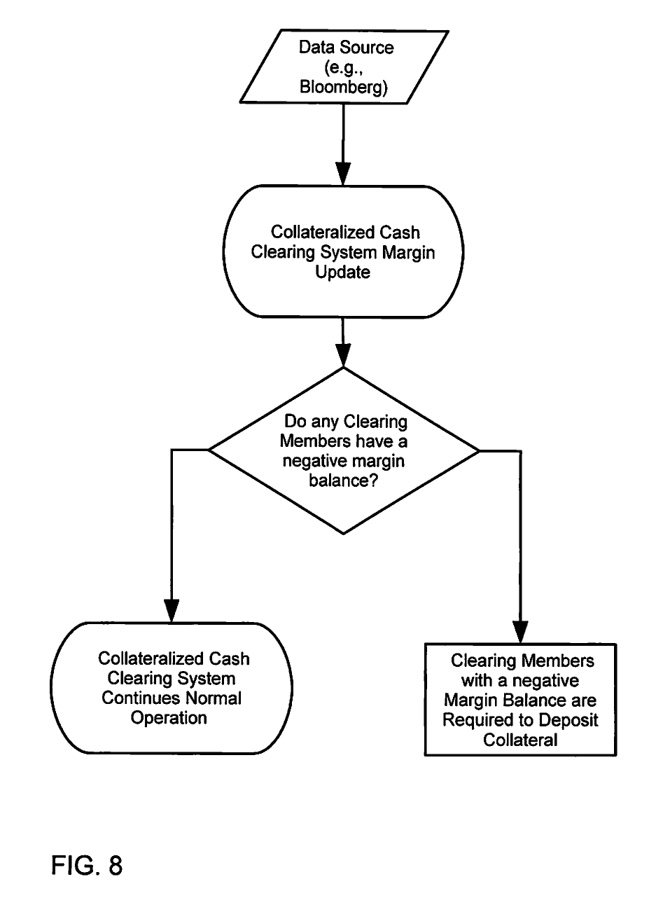

In some exemplary implementations the margin balance, margin value, and payment transaction amounts may be adjusted by the CCCS without the participation of the parties both before and after the clearing process. In this exemplary implementation as shown in FIG. 8, amounts may be adjusted for risk management purposes or when currencies are exchanged. If at any time a party's margin balance becomes negative due to these adjustments, the party will be requested to deposit additional collateral.

In an exemplary implementation risk management practices are employed throughout every transaction to maintain the stability of the CCCS. These risk management practices ensure that the system controls sufficient capital to guarantee all outstanding payments. These risk management practices are adjustable to account for geopolitical, economic, financial, or environmental instability. For example, in some exemplary implementations the value of a party's collateral, currency, or payment may be reduced to account for various risk factors. This is commonly termed a “haircut”. In another exemplary implementation, limits may be placed on the asset, asset class, or foreign currency that can be deposited with the system for collateral. This can allow for diversification in the system or to prevent an excess of volatile foreign currency from destabilizing the system.

In some exemplary implementations, risk management filters are used to implement risk management practices in the CCCS. In this exemplary implementation, risk management filters are applied to each transaction in the system. These filters can be tuned automatically or manually by a system administrator of the CCCS. For instance, the system may increase the haircut applied to a transaction of a particular currency if the currency is unstable.

Due to the fluctuating nature of foreign exchange rates, the system will adjust a party's margin value accordingly if confirmed payment or receipt transactions are made in a currency that is not the party's base currency. In some exemplary implementations these adjustments are made in real time. In other exemplary implementations, these adjustments are only made when transactions are being processed. Furthermore, in some exemplary implementations the foreign exchange rate for all currencies are manually entered by a system administrator. In other exemplary implementations the foreign exchange rates for each currency are obtained from a secure and trusted data source.

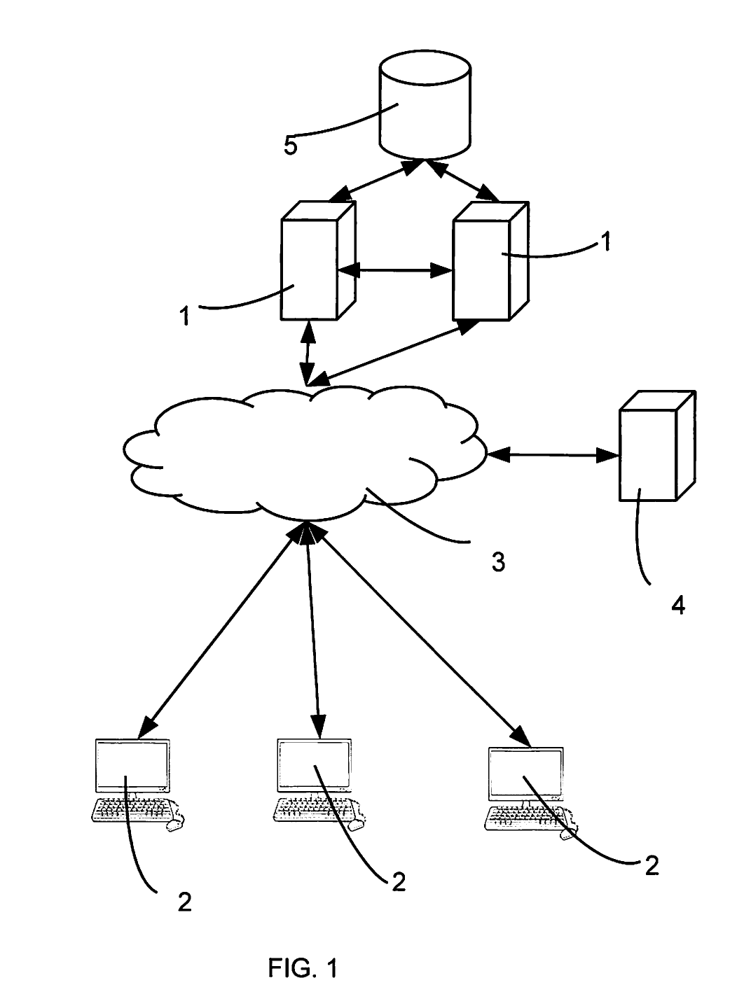

In another exemplary implementation of the present disclosure, a computer implemented method and system are provided for performing the method provided above. In this exemplary implementation, as shown in FIG. 1, one or more servers 1 and a plurality of client machines 2 are provided. The one or more servers 1 are independent of the parties and are used to fulfil the obligations, among other things. The parties to the obligations, that is, the payor and receiver parties, use the clients 2 to initiate transactions such as, for example, collateral or clearing balance deposits.

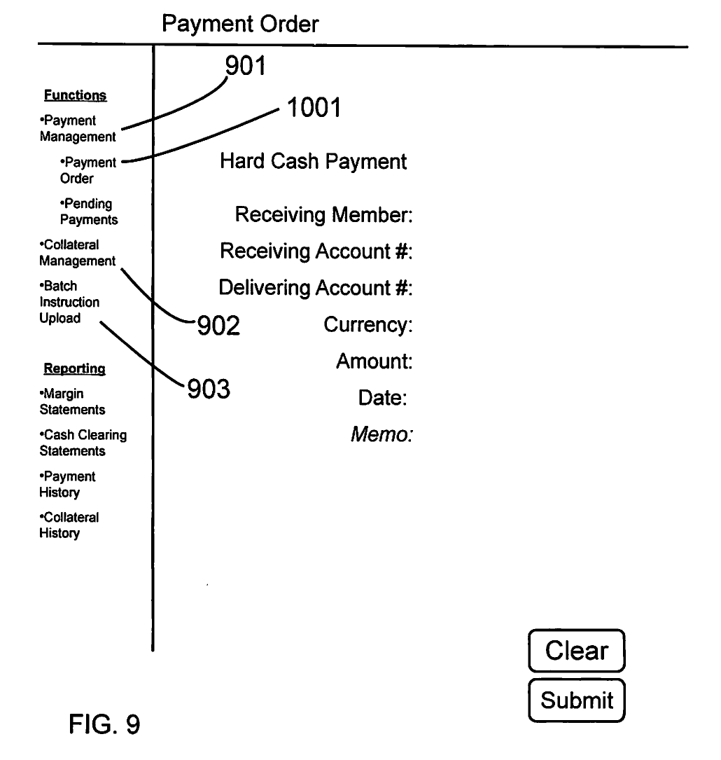

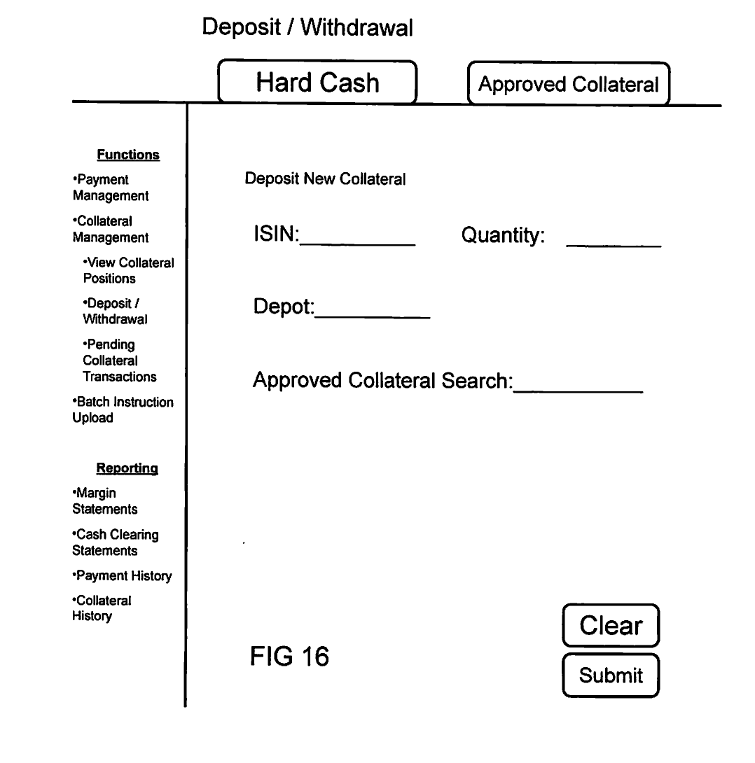

The client 2 provides access to the CCCS and allows parties to perform certain functions. These functions include, but are not limited to, initiating collateral deposits to the account, initiating a payment transaction request, initiating a deposit to the account, receiving messages from the system such as a notification of payment or notification of a deposit requirement, and obtaining status from the system. Status may include, but is not limited to, information such as the scheduled clearing date, a party's marginable balance, a party's collateral balance, the current exchange rates, and the status of the system. Exemplary implementations of client features are illustrated in FIGS. 9-29.

As illustrated in FIG. 1, in some exemplary implementations, the client 2 is a computer connected to the server through a secured global network 3 such as the internet. This computer has a display or graphical user interface (GUI) that allows a user to operate the client. In other exemplary implementations, the client 2 may be a browser such as Mozilla Firefox, Google Chrome, or Microsoft Internet Explorer installed on a general purpose computer, tablet, or smartphone.

In some exemplary implementations, the party may be able to access functionality associated with accounts outside of the system. For instance, the party may initiate withdrawals or deposits, through the client of the system, to accounts associated with third party systems 4. As will be discussed later, this functionality is implemented on the server side 1 of the CCCS. In this exemplary implementation, the server 1 is connected to the third party system through the secured global network 3.

In other exemplary implementations, the client 2 may also allow parties to administer their client 2 and their corresponding accounts. For instance, in the scenario where the party is a large organization such as a bank, the bank may wish grant several individuals access to the functionality provided by the client 2. In this exemplary implementation, the client 2 may allow parties to administer individual user accounts associated with the party's account. The client 2 may also allow different levels of access to ensure that each user has only the functionality required to perform his or her role. For instance, the party's information technology specialist may only be able to add or remove parties, whereas a foreign exchange trader may be able to initiate payment transactions.

In another aspect, the computer implemented method and system has one or more servers 1. Generally, the server 1 is responsible for processing transactions initiated from the client 2, clearing the transactions, fulfilling the transactions, and requesting that member parties deposit collateral or margin. Conceptually, the server 1 may be, but is not limited to, one or more enterprise-class servers located in a secure location, virtual servers in a cloud computing environment, or any other client-server solution.

In exemplary implementations where the client 2 is a browser, the server 1 may include a means to serve web pages. An exemplary of this would be a web server. Examples of web servers include, but are not limited to, Apache HTTPD and Microsoft Internet Exchange. These web servers are configurable to allow for secured connections between the browser running on the client 2 and the server 1.

In an exemplary implementation, the server 1 comprises a data store 5 for storing transaction, client, and system data. In some exemplary implementations, the data store 5 is managed by a relational database manager such as IBM DB2, Oracle, or MySQL. In other exemplary implementations, the data store 5 may be a custom designed data store optimized for transactional speed and security.

In other exemplary implementations, the server 1 may comprise an application programming interface (API). Clients 2 can then interact with the server 1 by sending requests to the server's 1 API. The server 1 may then acknowledge receipt of these requests, perform the command, and return a response to the client 2 that corresponds to a success or failure condition. From the client's perspective, this API allows parties to customize or develop their own client interfaces.

In some exemplary implementations, when the client 3 issues a request to the server 1, the server 1 will check whether the user is authorized to perform the requested transaction. For example, in some implementations the server 1 determines whether the user is authorized to perform the requested transaction by comparing the user information to user data. The server 1 may then return an error or notify administrators or both in the instance of an unauthorized access. In another example, the server may require that the user log into the system in order to determine the user's access rights.

After the request has been determined to be from an authenticated user, the server 1 fulfills the client's 2 requests. In some exemplary implementations, the server 1 may respond to the client 2. These responses can include, but are not limited to, acknowledgements that the transaction request was received, confirmations that the transaction has been completed, or error messages indicating that the transaction has failed.

In this exemplary implementation, client 2 requests can be categorized into three general categories: Functions 191, Reporting 192, and Administrative 193. Generally, functions 191 allow clients 2 and system administrators to initiate transactions, accept or reject transactions, deposit or withdrawal collateral, and deposit margin requirements. Reporting 192 allows users to view upcoming and historical payment, collateral, and margin transactions. Administrative 193 functionality allows clients to manage their passwords and to set user access levels for different client users.

If the user is a system administrator of the CCCS, then the client may have additional administrator functionality. In some exemplary implementations, the Administrator Functions 3001 allow a system administrator to approve, manually enter, or reject transactions. The Administrator Reporting 3002 functions allow CCCS system administrators to request reports on the entirely of the system. The administrative 3003 functionality for system administrators allows system administrators to manage client accounts and parties, manage approved assets and asset classes for collateral, manage approved currencies for transactions, manage clearing timing, manage depository settings, and other functionality related to system administration.

### Client Payment Functions

In an exemplary implementation, client functions that are processed by the server include “payment management” 901, “collateral management” 902, and “batch instruction upload” 903. Payment management functions 901 include “payment order” 1001 and “pending payments” 1002. Collateral management 902 functions include “view collateral positions” 1201, “deposit/withdrawal” 1202, and “pending collateral transactions” 1203.

When the server receives a “payment order” 1001 request from the client 2, the server 1 initiates a payment transaction request from the client party's account to a second member party. FIG. 9 shows an exemplary implementation client payment order interface. The payment order interface is used to collect payment order data from the payor party in order to generate a payment transaction. The payment order interface may automatically include data it knows of, for example the payor party information, in the payment transaction.

The payment transaction comprises payor information, receiver information, the transaction amount, the currency of the transaction, a note or memo field, and date information corresponding to when the transaction was created, recorded, or last edited. The payment transaction data may also include a status field that allows the system to flag the status of the transaction. In this exemplary implementation, the status may identify the transaction as being pending, approved, pending approval, cancelled, denied, and fulfilled.

The payment transaction is then recorded in the data store 5. In this exemplary implementation, the data store 5 stores payment transaction information from all payment order requests from all parties in a single data table. Alternate configurations can be used without departing from the scope of this disclosure. For example, in other exemplary implementations, each party may have their own data table.

In another exemplary implementation, when the server receives a “pending payments” 1002 request, the server will retrieve all incoming and outgoing pending payment transactions from the data store 5 and present it to the user through the client 2. In some exemplary implementations, this data may be presented for informational purposes only. In this exemplary implementation, outgoing payment transactions can be edited by the payor or the system administrator at any time before the clearing window begins. This allows the payor or the system administrator to adjust the payment in the case of error, changing market conditions, or any other reason that would require the modification of a payment.

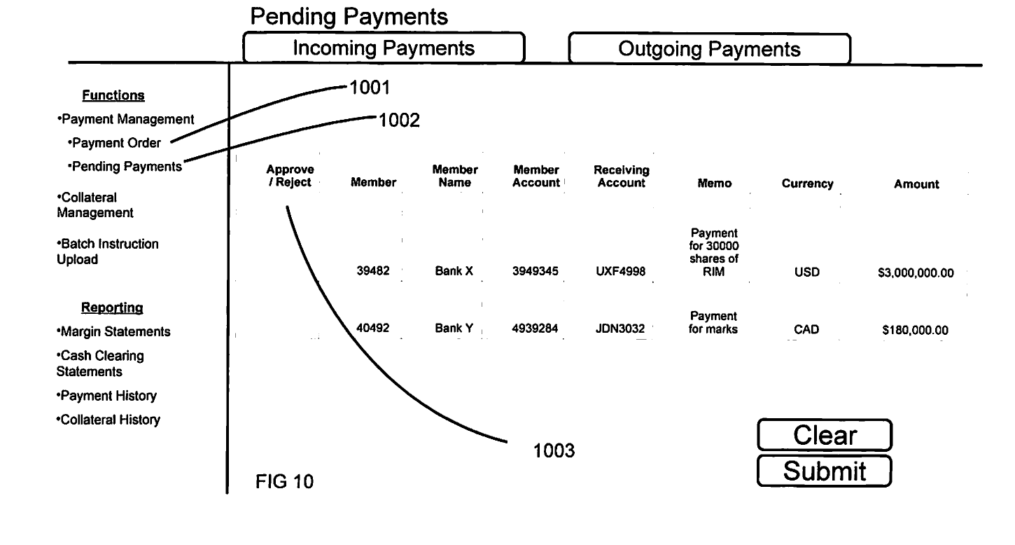

In this exemplary implementation as shown in FIG. 10, the incoming “pending payments” 1002 request retrieves all pending incoming payments to the party from the data store 5. These incoming payments are from other parties of the CCCS. As was discussed above, these incoming transactions can be edited or deleted by the payor party at any time prior to the clearing window. In other exemplary implementations, the incoming transactions can be edited or deleted by the payor party at any time before the payment is approved by the receiver.

In this exemplary implementation, the receiving party can either reject or confirm 1003 the incoming payment. Rejecting the payment changes the status of the payment transaction, as stored in the data store 5, to “rejected”. Confirming the payment changes the status of the transaction to “accepted-pending”. Payment transactions with the status of “accepting-pending” will be fulfilled during the clearing period. In the implementation where a payment transaction comprises a payor and receiver transaction pair, both the payor and receiver transactions will be updated in the data store 5.

In some exemplary implementations, the “accepted-pending” transactions can also be used to adjust the margin balance of both parties. In the case of incoming payments, the CCCS will increase the receiving party's available margin for payment transactions. In this exemplary implementation, the value of an approved incoming payment will be reflected in the party's soft cash margin balance. This amount can then be used by the party to initiate unrelated payment transactions to another party.

In the case of outgoing payments, the CCCS decreases the payor party's available margin balance for payment transactions. In this exemplary implementation, the value of an approved outgoing payment is reflected in the party's margin balance.

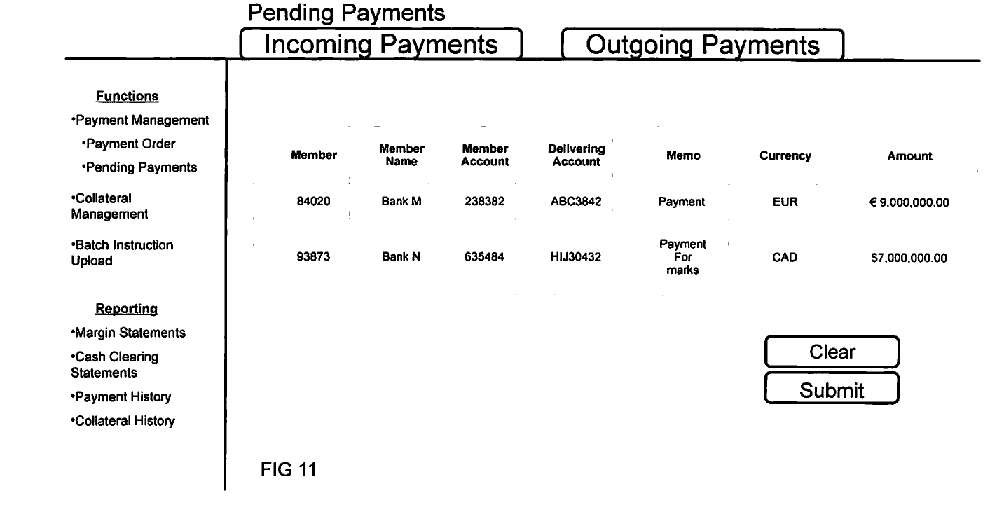

In another exemplary implementation as shown in FIG. 11, the outgoing “pending payments” 1001 request retrieves all pending outgoing payments from the party to the data store 5. These outgoing payments are payments to other parties of the system. As was discussed above, these payment transactions can be edited through the client 2 at any time prior to the clearing window or prior to the payment being approved by the receiver. In another exemplary implementation, these transactions may be cancelable. In some exemplary implementations, when a transaction is cancelled it is deleted from the data store 5. In other exemplary implementations, the status of the transaction may be changed to “cancelled”.

Furthermore, in the exemplary implementation where payment transactions comprise a payor and receiver pair, both the payor and receiver transactions will be updated. In this exemplary implementation, if a receiver has approved a payment transaction such that the status of the receiver transaction is “approved-pending” before the payor party edits the payment transaction, then the receiving party may need to re-approve the receiving transaction. That is, when the payor party makes the change to the payment transaction, the payor and receiver transactions will be updated and its states will be changed to “pending” in the data store 5. The receiving party will then need to re-approve or reject the edited transaction.

### Client Functions

In another exemplary implementation, when the server 1 receives a “view collateral positions” 1201 request from the client 2, the server 1 will retrieve data related to the party's collateral position from the data store 5. This data may include the party's hard cash collateral 1204 and approved collateral 1205 positions. In some exemplary implementations, a reporting screen will be presented to the user through the client 2 that summarizes the client's current collateral positions, as well as providing a detailed description of each collateral position entry. In some exemplary implementations, this report may also provide information regarding the remaining margin balance corresponding to the collateral.

In an exemplary implementation, collateral data is stored in the data store 5 in the same data table as payment data. Collateral data, however, is marked as collateral to distinguish it from payment data. When the “view collateral” request for hard cash 1204 is being processed, the server adds the value of the hard cash collateral. When the “view collateral” request for assets 1205 is being processed, the server adds the value of the asset collateral.

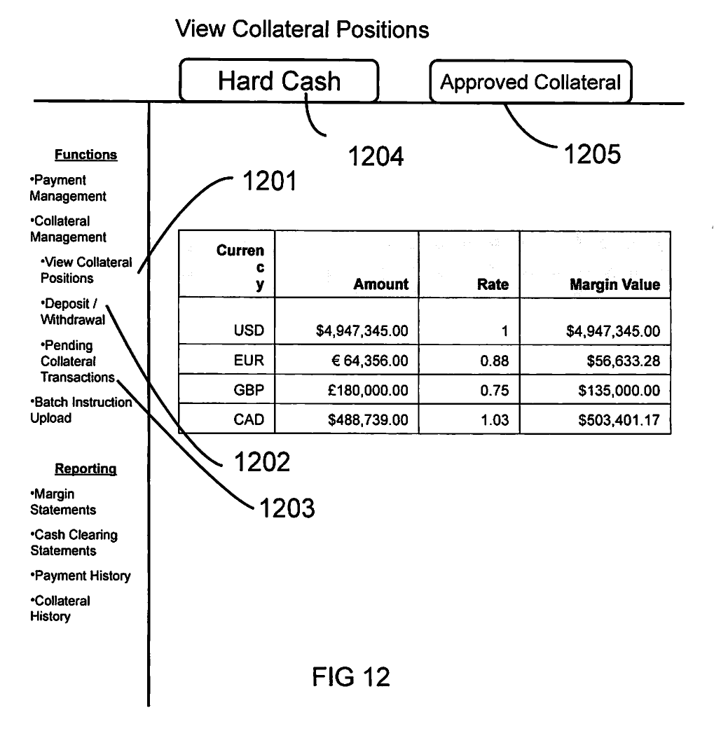

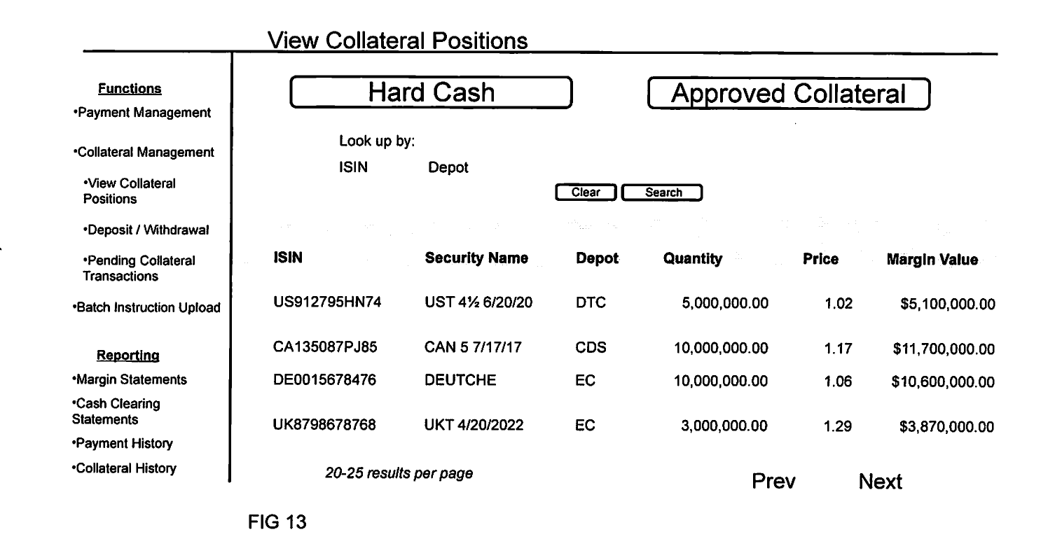

In this exemplary implementation, the CCCS can also determine a margin value corresponding to the value of the collateral. In this exemplary implementation, as shown in FIGS. 12 and 13, the margin value is the value of the collateral (whether hard cash or assets) converted to the party's base currency. In other exemplary implementations, risk management filters may be applied to further reduce the margin value. In yet another exemplary implementation, the margin balance may be the total value of the hard cash and the assets minus any uncleared outgoing payments made by the party. This margin balance, as was previously discussed, represents the amount available for payment transactions as valued in the party's base currency.

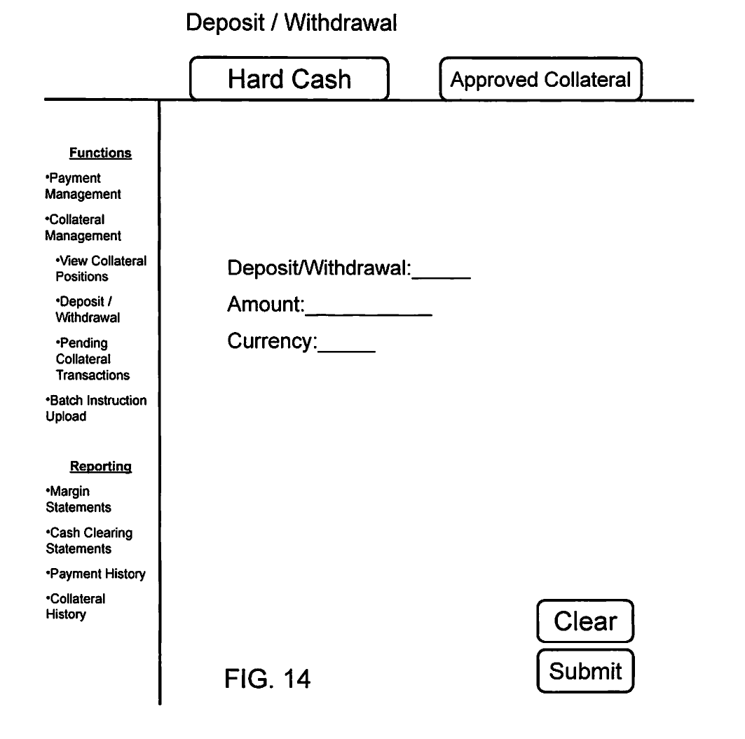

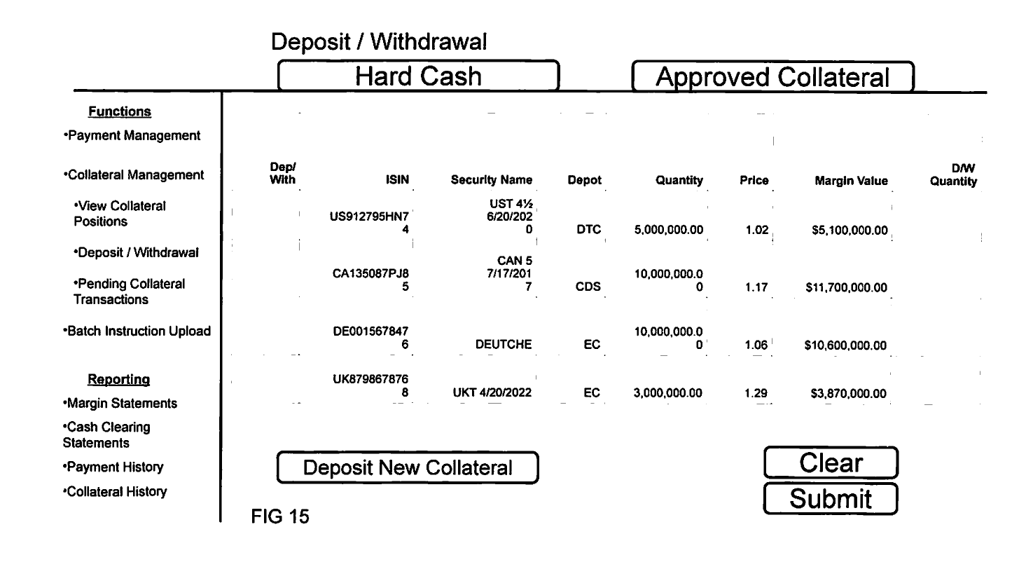

In another exemplary implementation as shown in FIGS. 14 and 15, the party can initiate a deposit or withdrawal transaction of hard cash or assets to the CCCS. In this exemplary implementation, the request is sent from the client 2 to the server 1. The server 1 can communicate with external systems through a global secured network 3 to transfer collateral between the CCCS and external systems 4. These external systems 4 can include, but are not limited to, banks, security depositories, and other financial systems such as clearing houses. In other exemplary implementations, deposits and withdrawals of hard cash can be performed using wire payments or other means of transferring cash to the possession of the party. In some exemplary implementations this may include transferring the funds to a third party institution, such as an agent bank.

In this exemplary implementation, the client interface as illustrated in FIGS. 14 to 16 collects the requisite data from the party to complete a collateral transaction. In the exemplary implementation for hard cash, this can include the transaction type (deposit or withdrawal), the amount, the currency, and the source of the funds. This source can include links to external financial institutions or wire transfer identifiers. In the exemplary implementation for assets, this data can include the transaction type (deposit or withdrawal), data identifying the security, the quantity of the security to be transferred, and depository information, among other data. This data is then stored in the data store 5.

In this exemplary implementation, depositing hard cash or assets increases the party's margin balance for use in payment transactions. In some exemplary implementations, risk management filters may be applied so that the margin value is less than the actual value of the hard cash or asset. Furthermore, withdrawing hard cash or assets reduces the party's available margin balance for use in payment transactions. In this exemplary implementation, withdrawals will be rejected if the withdrawal transaction causes the margin balance to drop below a fixed amount. In this exemplary implementation, a party cannot withdraw collateral if withdrawing collateral will result in a negative margin balance.

In some exemplary implementations, when a payment or deposit is made in a currency other than the party's base currency a reduction factor, or “haircut”, will be applied. This haircut, which can be considered a specific risk management filter, accounts for variances and swings in the global currency market. In an exemplary implementation, a 5% reduction to value may be applied to the payment or deposit to account for this risk. Alternatively, the reduction rate can be set by the CCCS system administrator and that the rate can be adjusted based on the volatility of the market.

In another exemplary implementation, collateral transactions such as deposits or withdrawals of hard cash or assets must be approved by a CCCS system administrator before the deposit or withdrawal transaction is fulfilled. Prior to these transactions being approved, the client can instruct the server to display all collateral transactions that are awaiting approval.

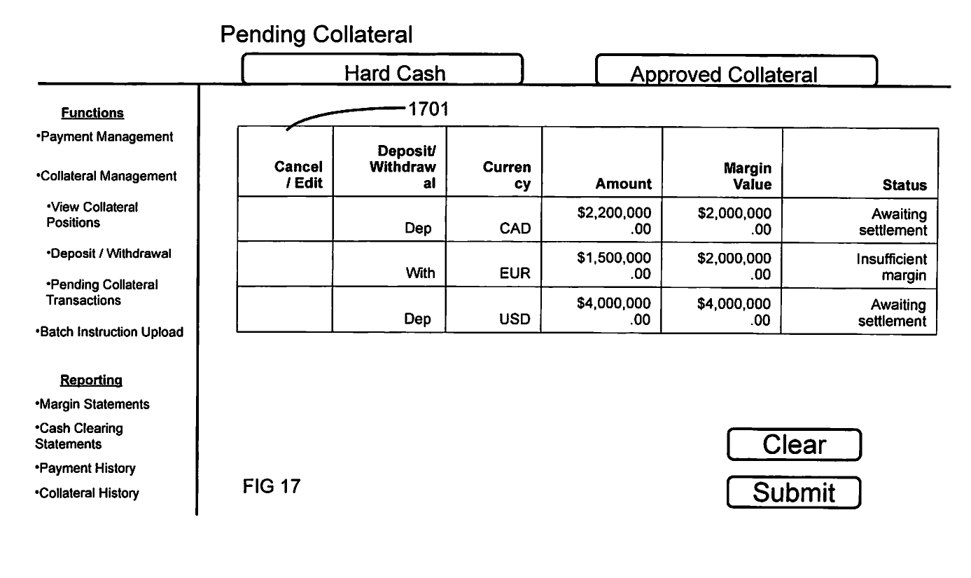

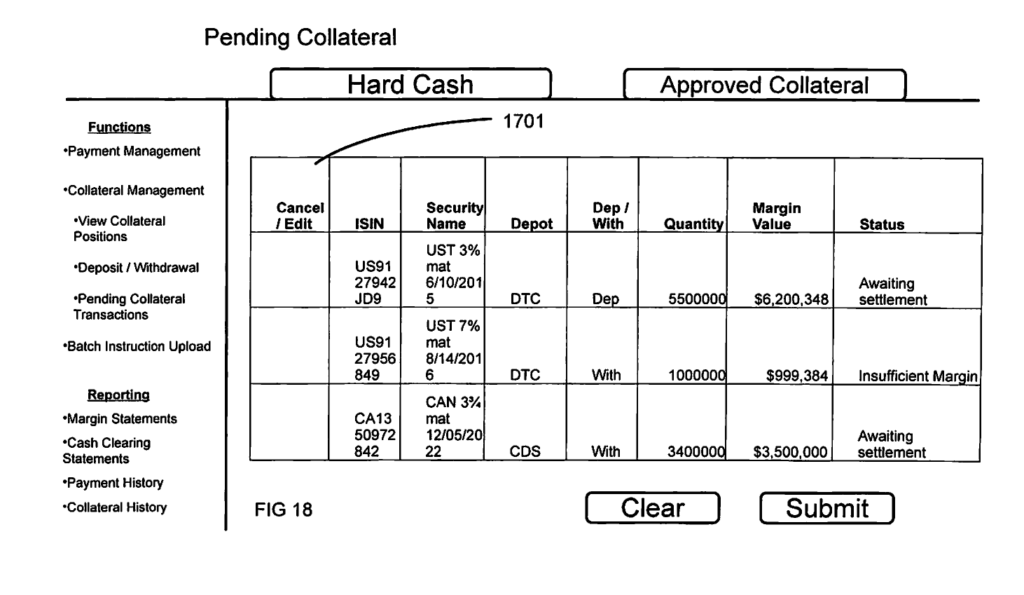

In the exemplary implementation where pending collateral transactions must be approved by the CCCS or a system administrator of the CCCS, the server 1 may be configured to retrieve pending collateral data from the data store 5 and generate a “pending collateral” report. This report, when presented to the party through the client 2, shows all collateral transactions that have yet to be approved. Exemplary implementations of these reports are illustrated in FIGS. 17 and 18, where FIG. 17 shows a pending collateral report for hard cash and FIG. 18 shows a pending collateral report for approved collateral.

In the exemplary implementation shown in FIGS. 17 and 18, the party may also cancel or edit 1701 pending collateral transactions. This allows clients to modify the collateral transaction at any time prior to the system administrator approving the collateral transaction. This can be useful in circumstances where, for example, a mistake was made.

### Client Reporting

In another exemplary implementation, the client 2 can request reports from the server 1. Reporting functions can include, but are not limited to, “margin statements”, “cash clearing statements”, “payment history”, and “collateral history”. In the “margin statement” and “cash clearing statement” reporting functions, the client can request a summary or detailed version of the selected report. In the “collateral history” reporting function, the client can request a historical report for both hard cash and asset collateral.

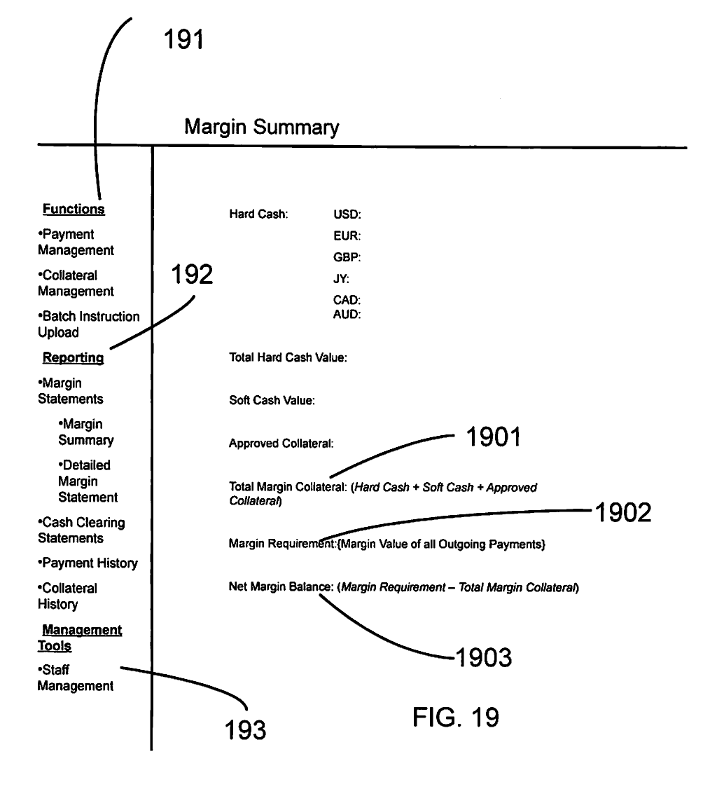

In an exemplary implementation, the server 1 is configured to retrieve data from the data store 5 and generate one or more reports related to the party's margin. These reports are then sent to the client 2 for presentation to the user. In one exemplary implementation shown in FIG. 19, a summary report of the party's margin can be generated. The report summarizes the party's available hard cash, soft cash (i.e., pending and fulfilled payment orders), and assets. The total margin collateral 1901 can then be determined by adding the values of the hard cash, soft cash, and assets, and subtracting any risk management and currency conversion adjustments.

In some exemplary implementations the margin summary report may also include the party's total margin requirement 1902. In the case where the clearing window has not yet passed, this number represents the value of all outgoing payment orders yet to be fulfilled. In the exemplary implementation where the margin summary report shows negative margin balances after the clearing window has completed, this value represents the amounts that must be deposited to the system to prevent the collateral from being liquidated.

In another exemplary implementation, the margin summary report may also provide information regarding the net margin balance 1903. This value represents the remaining margin balance available for outgoing payment transactions. In this exemplary implementation, the margin balance is the total margin collateral minus the margin requirement.

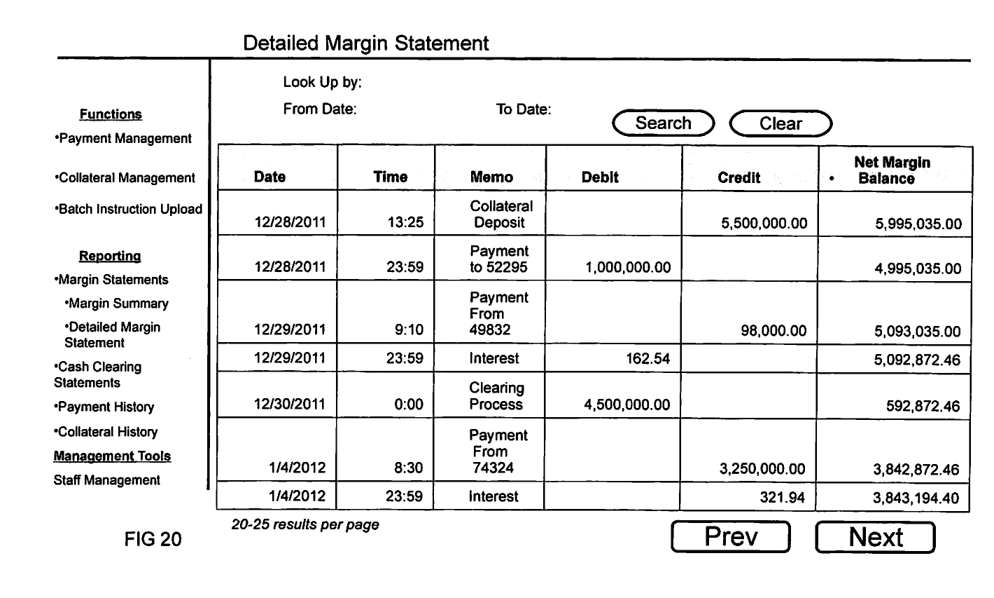

In another exemplary implementation as shown in FIG. 20, the server 1 may also be configured to retrieve data from the data store 5 and generate a detailed margin statement for display by the client 2. In this exemplary implementation, the server 1 will retrieve and generate a list of transactions that affect the party's margin balance. These transactions may include, but are not limited to, incoming and outgoing payments. In some exemplary implementations, the report may also allow a party to generate a report for transactions that occurred between a range of dates.

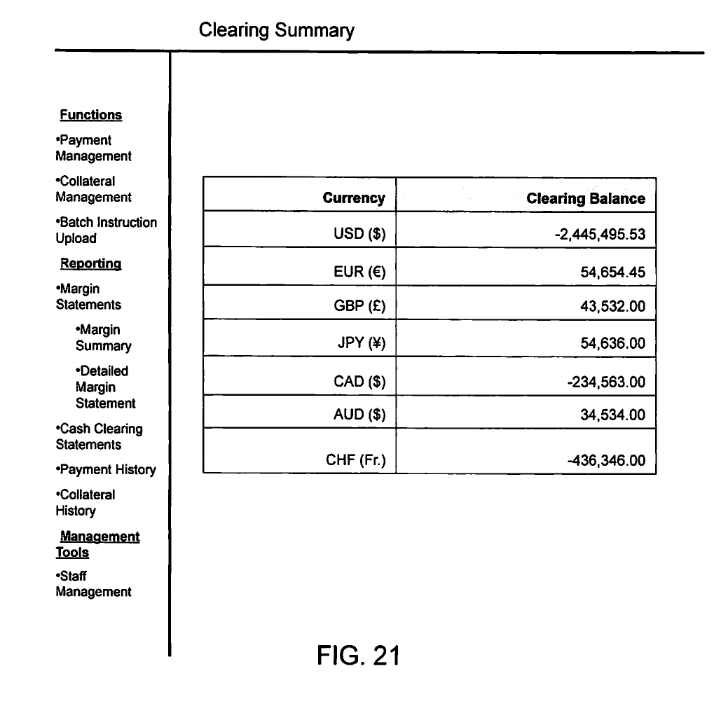

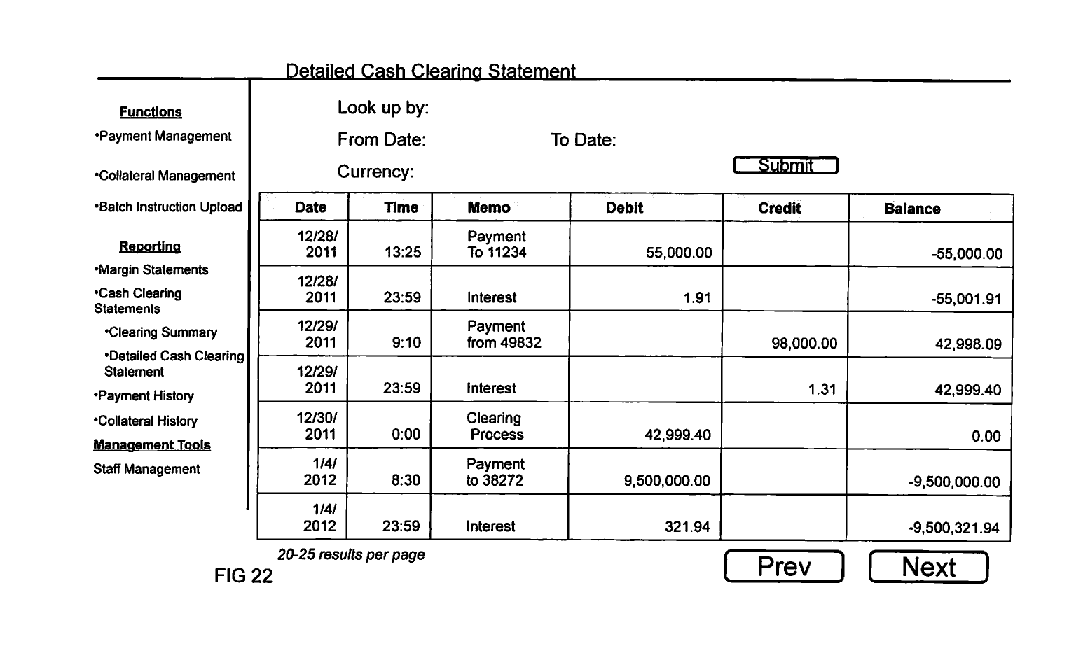

In another exemplary implementation as shown in FIGS. 21 and 22, the server 1 is configured to retrieve data from the data store 5 and generate one or more reports related to the party's cash clearing transactions for display by the client 2. In this exemplary implementation, the server 1 can generate a summary of all uncleared outgoing and incoming payments for each accepted currency. In the case where no transactions are made in an accepted currency that currency is not displayed in the report. In this clearing summary, all incoming payments are represented as a positive value, whereas all outgoing payments are represented as a negative value. In some exemplary implementations where the party must accept the incoming transaction, this incoming value will not be included in the clearing balance until the transaction has been approved by the party.

In another exemplary implementation as shown in FIG. 22, the server 1 is configured to retrieve data from the data store 5 and generate a detailed report of the party's cash clearing transactions for display by the client 2. In this exemplary implementation, the server 1 will retrieve details for each of the incoming and outgoing transactions for a selected currency and a given date range. The date and time of the transaction and a memo describing the transaction may also be retrieved from the data store. The credit or debit value of the transaction is also retrieved, as is the margin balance at the time of the transaction. The server 1 then organizes this data for presentation through the client 2. This report can be useful for accounting, tracking, and administrative purposes.

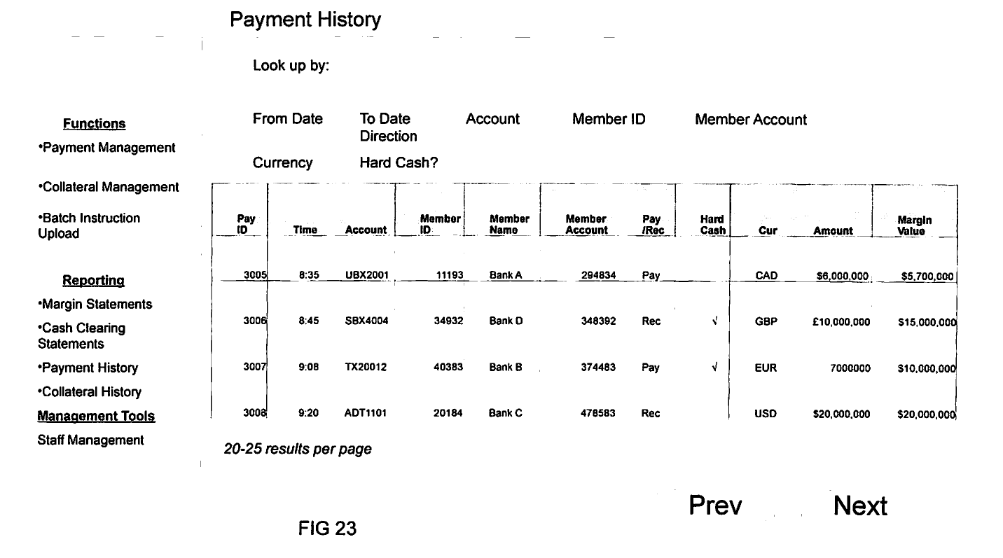

In another exemplary implementation as shown in FIG. 23, the server 1 is configured to retrieve data from the data store 5 and generate a report of the party's payment history for display by the client 2. This report allows a party to search through their incoming and outgoing payment transactions. In this exemplary implementation, the party can search for payment transactions based on a date range, an account number, another party in the system, a currency, by direction, and whether the transaction is a hard cash transaction. In some exemplary implementations, incoming transactions are recorded as “rec” (i.e., received) transactions, and outgoing transactions are recorded as “pay” transactions.

The server 1 will then retrieve all payment transactions from the data store 5 that meet the search criteria. In the exemplary implementation where payment transactions are made in currencies other than the base currency, the margin balance will be adjusted based on the prevailing exchange rate for that currency. Furthermore, the margin balance displayed in the report may also be adjusted by the various risk management filters.

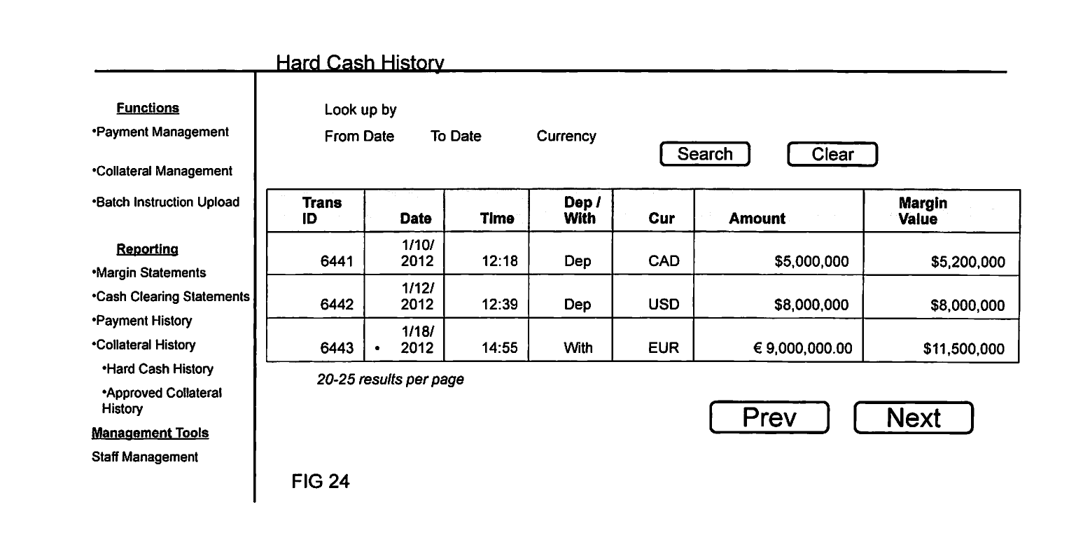

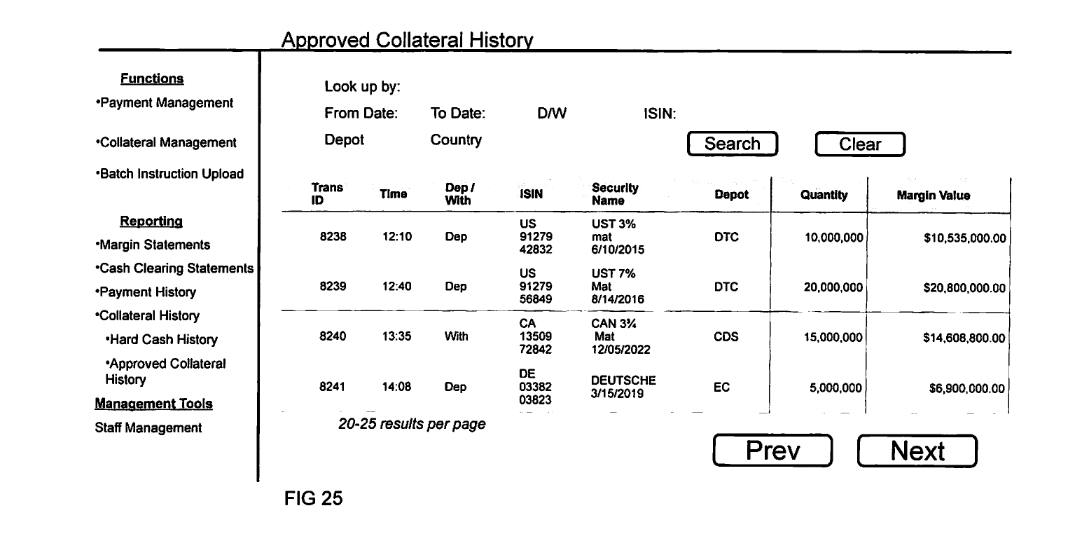

In another exemplary implementation as shown in FIGS. 24 and 25, the server 1 is configured to retrieve data from the data store 5 and generate a report of the party's collateral history for display through the client 2. This can include reports on the party's hard cash and asset collateral positions.

In some exemplary implementations a party may search for collateral deposit and withdrawal transactions over a date range. Furthermore, depending on the type of collateral, additional search fields may be provided. In the case of hard cash collateral transaction reporting as shown in FIG. 24, the party may also search by the type of currency. In the case of asset collateral transaction reporting as shown in FIG. 25, the party may search on the security identifier (ISIN), the depository depot, and whether the transaction was a deposit or a withdrawal.

### Client Management Tools

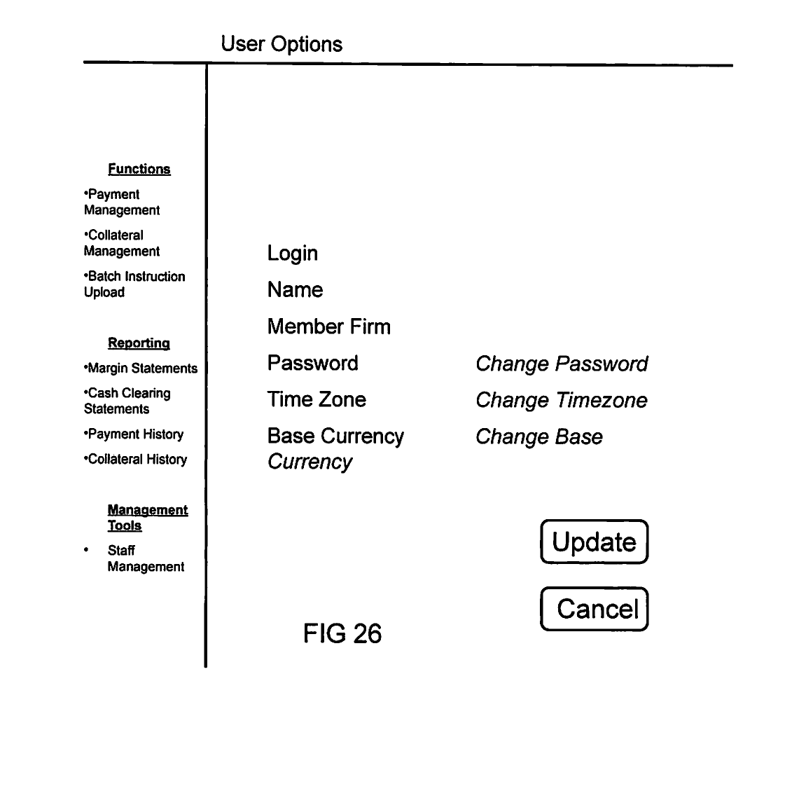

In some exemplary implementations, the member party may be able to manage staff and account logins for users associated with the party. In the exemplary implementations shown in FIGS. 26 to 29, parties can add, edit, and delete users. Parties may also be able to set a user's access level, which will determine the functionality available to the user through the client 2. In these exemplary implementations, the server 1 may validate the data input through the client 2 to ensure that data, for example, is formatted correctly. The server 1 then stores the data in the data store 5.

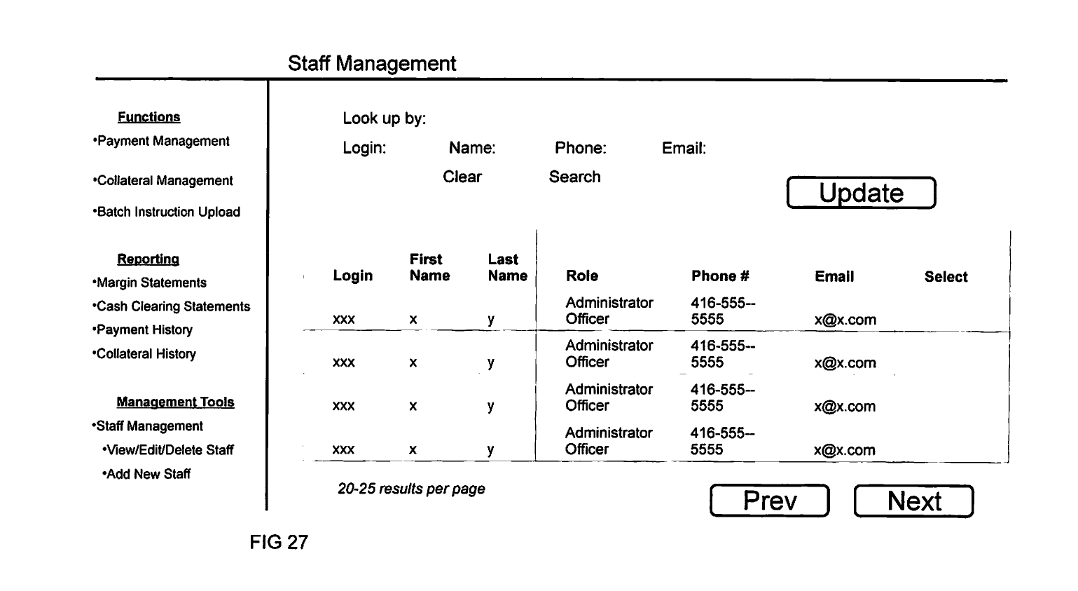

In this exemplary implementation as shown in FIG. 27, the party can retrieve user data. In this exemplary implementation, the server 1 is configured to retrieve data from the data store 5 and present it through the client 2. The party may filter the data based on the username, actual name, phone number, or email, among other things. In this exemplary implementation the party may also update the user's credentials. Any updates are stored, by the server 1, in the data store 5.

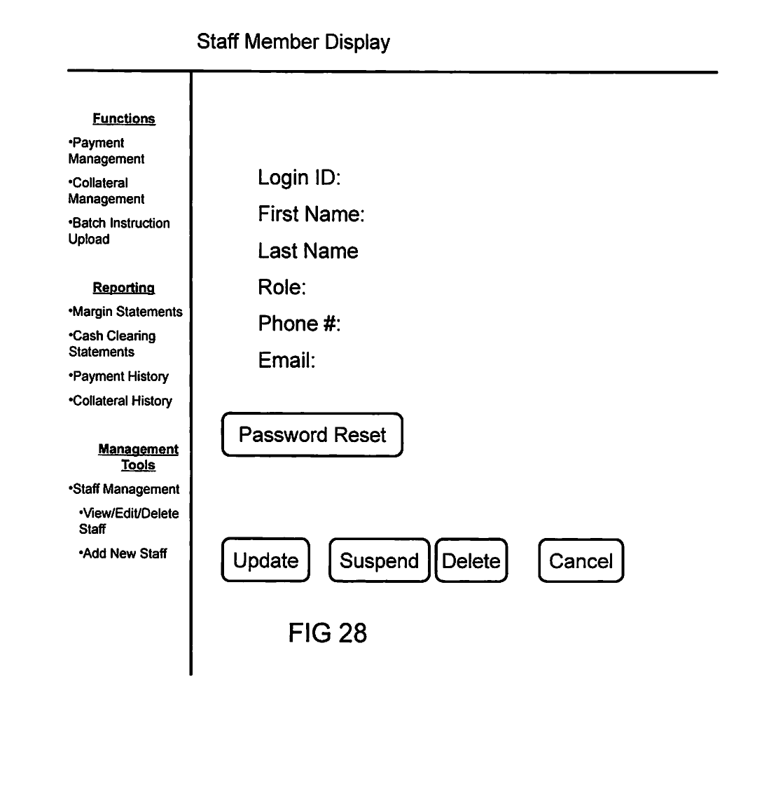

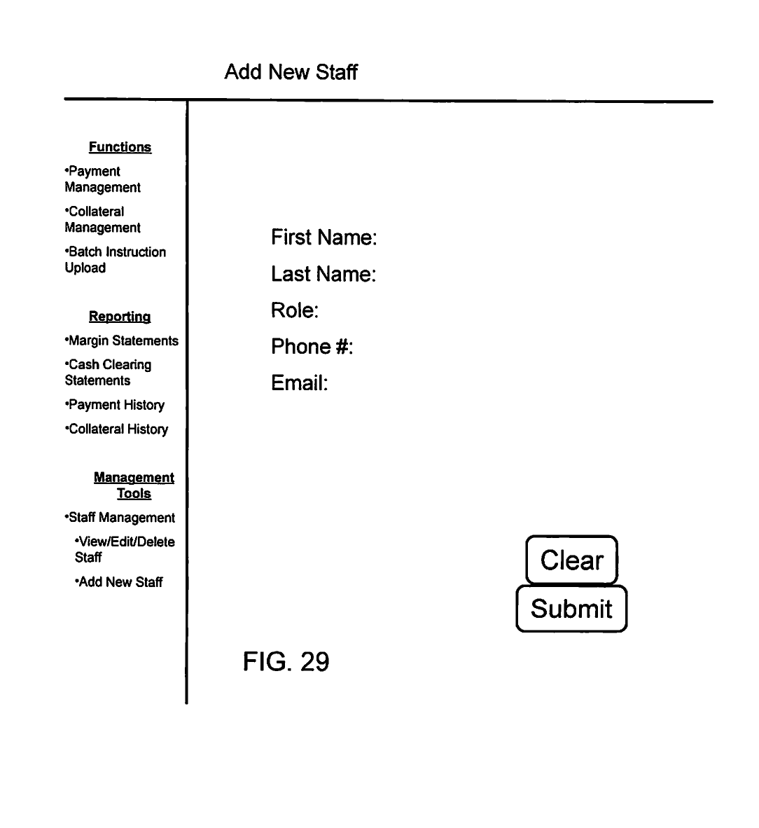

In another exemplary implementation as shown in FIG. 28, the party can update, suspend, or delete a specific user. The party may also reset the user's password in the event that the password is lost or otherwise compromised. The party can also add a new user as shown in FIG. 29. In each of these cases the server 1 is configured to update the data store 5 accordingly.

### CCCS System Admin Interface

In the exemplary implementation where the user is a CCCS system administrator, the user may be presented with the administrative functionality described below. Depending on the administrator's authorization level, some or all of the functions described below may be available.

In an exemplary implementation, the CCCS system administrator's interface can be divided into three main sections: “functions” 3001, “reporting” 3002, and “administration” 3003. The “functions” section allows the CCCS system administrator to perform functions on the transactions such as removing, editing, approving, or rejecting transactions. The “reporting” section allows the CCCS system administrator to generate reports related to the CCCS such as pending or historical payment, collateral, or clearing transactions. The “administration” section allows the CCCS system administrator to administer the CCCS. This can include, but is not limited to, updating exchange rates, collateral prices, interest rates, scheduling clearing windows, updating depository information, clearing member or party information, and similar administrative tasks.

In some exemplary implementations, client transactions such as payments and collateral transactions may need to be confirmed prior to the system accepting the transaction. In some exemplary implementations, the system may automatically review and confirm these transactions based on risk management principles. In other exemplary implementations, a CCCS system administrator may need to review and confirm the payment and collateral transactions. In other exemplary implementations the CCCS system administrator may be able to manually enter collateral and payment transactions. This functionality is useful in scenarios where a network outage prevents parties from initiating transactions.

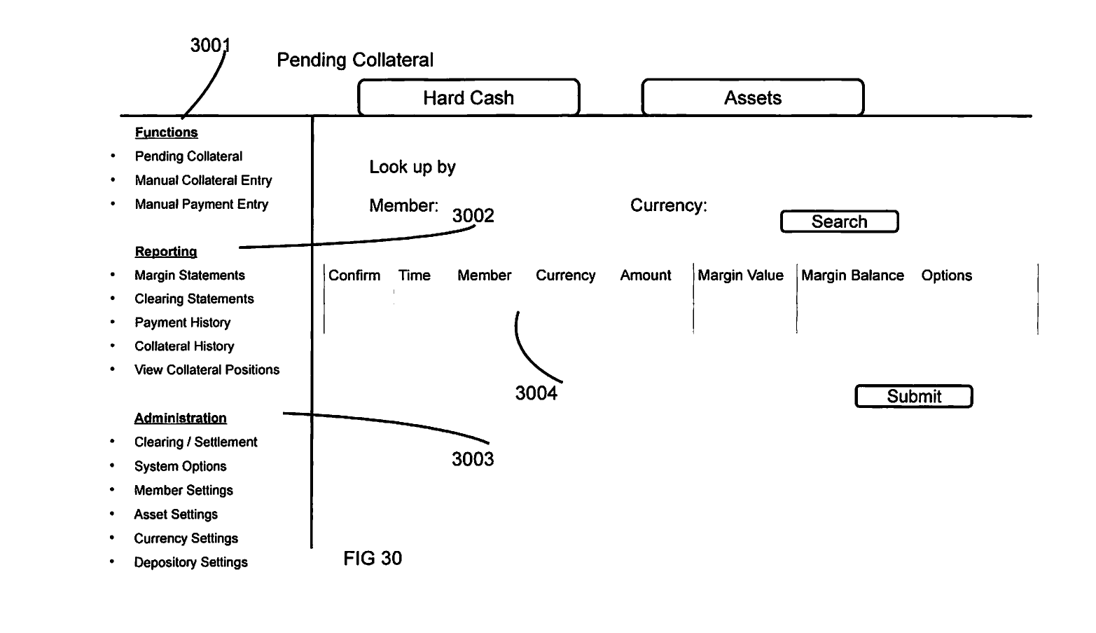

In an exemplary implementation as shown in FIG. 30, a CCCS system administrator may review and confirm collateral deposits and withdrawals of hard cash and assets. In this exemplary implementation, after the party has initiated a transaction through the collateral deposit/withdrawal interface (e.g., FIGS. 14 to 16), the collateral transaction is stored in the data store 5 as “pending review”. This indicates that the transaction should be reviewed before it can be fulfilled. It should be noted that any transaction that is denied, not approved, or is not confirmed will not be committed during the clearing window.

In some exemplary implementations, the CCCS automatically reviews and confirms pending collateral transactions that meet the system's risk management criteria. Any transactions that fail to meet the system's risk management criteria are rejected. In some exemplary implementations, the party may be notified of the rejection.

In the exemplary implementation shown in FIG. 30, one or more CCCS system administrators may review and confirm the pending collateral transactions. In this exemplary implementation, the server 1 retrieves data from the data store 5. In this exemplary implementation, this data is a list 3004 of all pending collateral deposits, both hard cash and assets. This list is then provided to the CCCS system administrator, through the client 1, for review. The CCCS system administrator may filter this list based on the currency and member identifier. The CCCS system administrator then reviews the transaction to determine whether it meets the system's risk management criteria. Transactions that meet the risk management criteria are confirmed, whereas transactions that fail the risk management criteria are rejected. The change is then recorded in the data store 5. In this exemplary implementation, the existing transaction record in the data store 5 is updated to reflect whether the transaction was accepted or rejected.

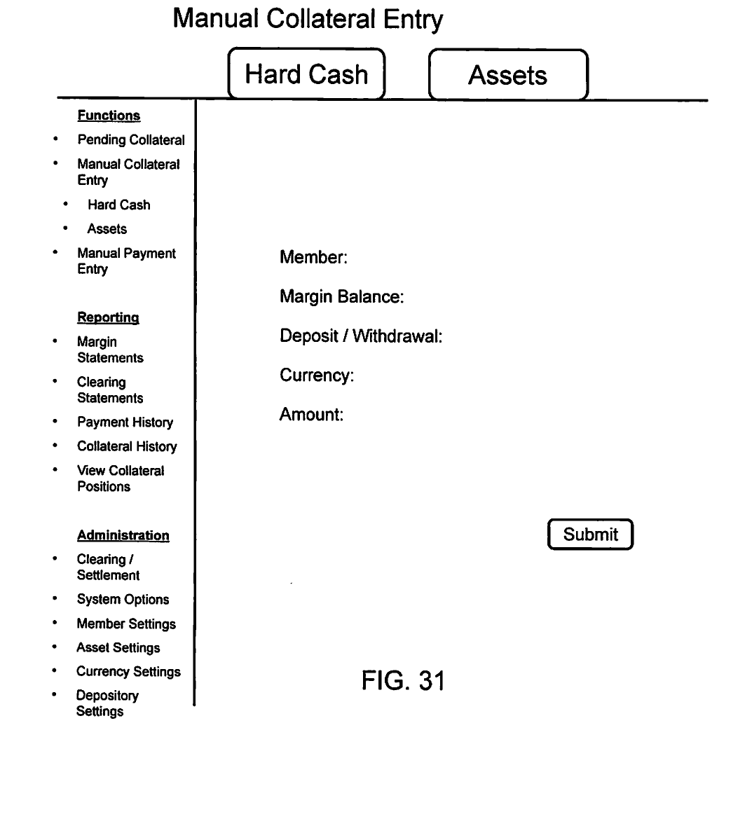

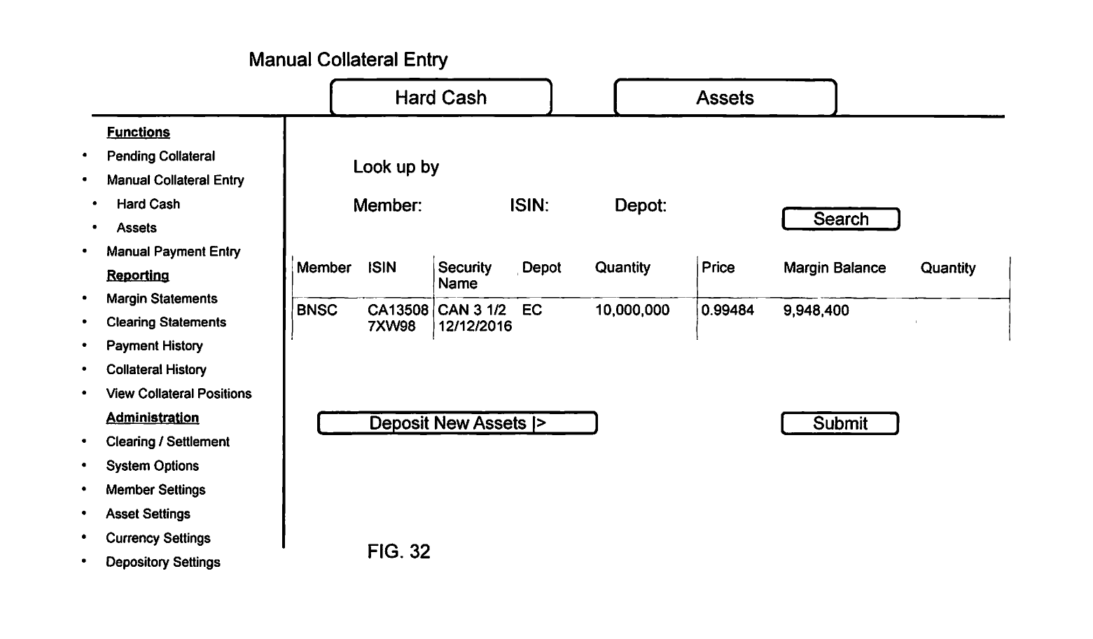

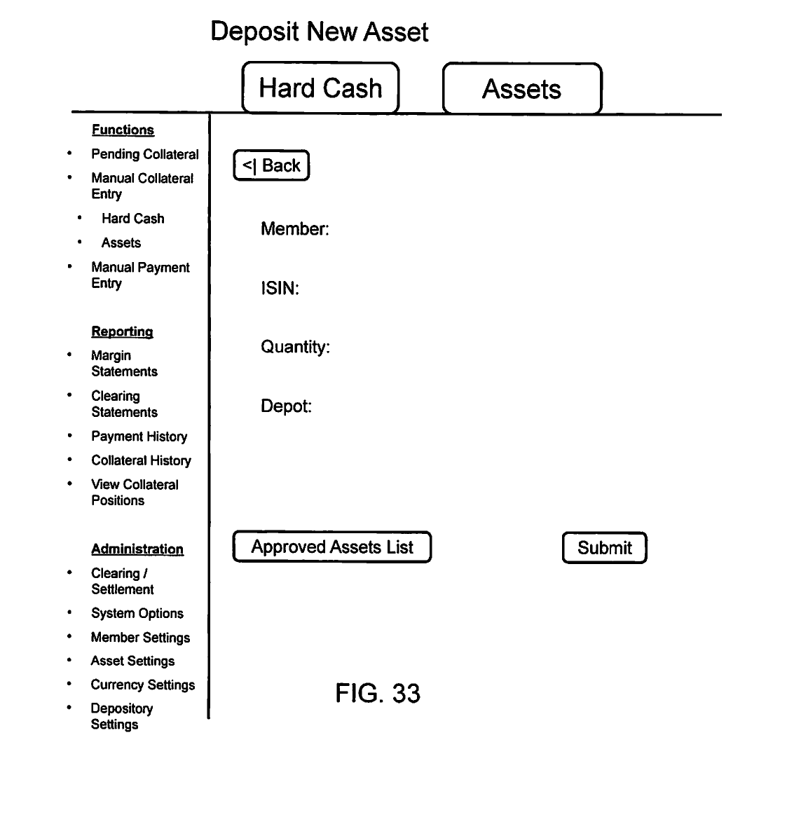

In another exemplary implementation as shown in FIGS. 31 to 33, the system allows a CCCS system administrator to manually enter collateral transactions of both hard cash and assets on behalf of a party. This allows collateral deposit or withdrawal transactions to be made even in the event of a network outage. In this exemplary implementation, a party contacts a CCCS system administrator and instructs the CCCS administrator to manually enter a collateral transaction. The administrator then enters the transaction using the instructions provided by the party. In the case of hard cash, the CCCS system administrator is required to enter the type of the transaction and the amount and type of currency into a client interface such as the one shown in FIG. 31. In the case of an asset, the system administrator is required to enter information related to the asset into a client interface such as the one shown in FIGS. 32 and 33. This may include, but is not limited to, the asset type, the amount, the depository, and the ISIN number. This information is then stored in the data store 5 as a collateral transaction, in the same location collateral transactions would typically be stored.

In some exemplary implementations, when a CCCS system administrator manually enters a collateral transaction into the system, the collateral transaction is automatically confirmed. That is, the system administrator can apply the risk management filters as the transaction is being entered into the system. In another exemplary implementation where the system automatically handles risk management, risk management filters will be applied to the transaction before the transaction is confirmed.

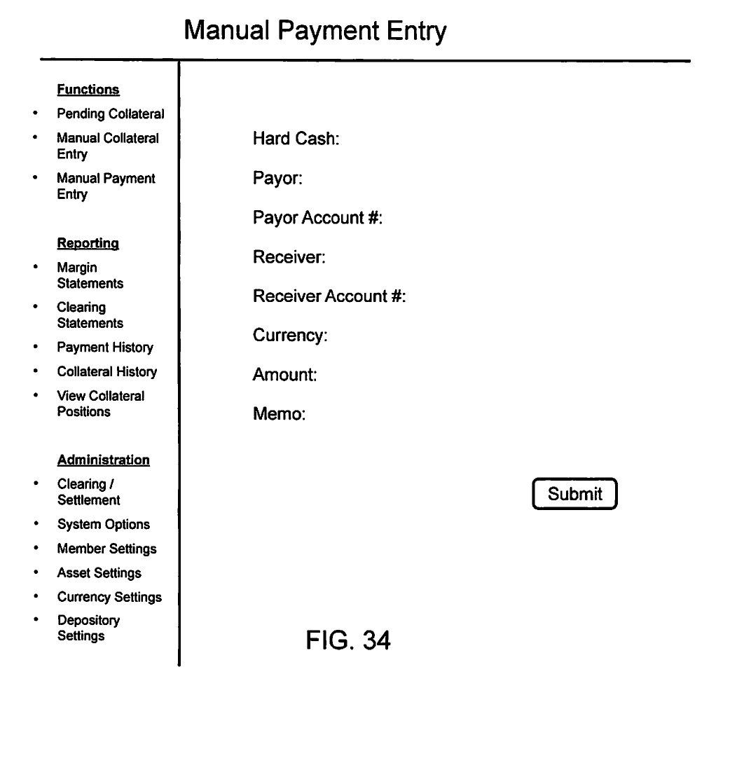

In another exemplary implementation as shown in FIG. 34, the system allows for payment transactions to be entered manually by a CCCS system administrator for similar reasons to the manual collateral entry functionality described above. In this exemplary implementation, the party contacts a CCCS system administrator and instructs the administrator to manually enter a payment transaction. This communication can include emails from a verifiable email account, faxes, etc. In another exemplary implementation, the CCCS administrator can verify that the communication originated from a party. For example, a CCCS administrator may require a passcode or phrase before accepting the instruction from the party.

The administrator then enters the transaction using the information provided by the party into the interface as shown in FIG. 34. This information is then sent to the server 1 where this transaction is stored in the data store 5. In some exemplary implementations, the risk management filters will be applied as the transaction is entered into the system, similar to the risk analysis filters applied during a manual collateral transaction. In other exemplary implementations, the risk management filters will be applied to the transaction before the transaction can be confirmed.

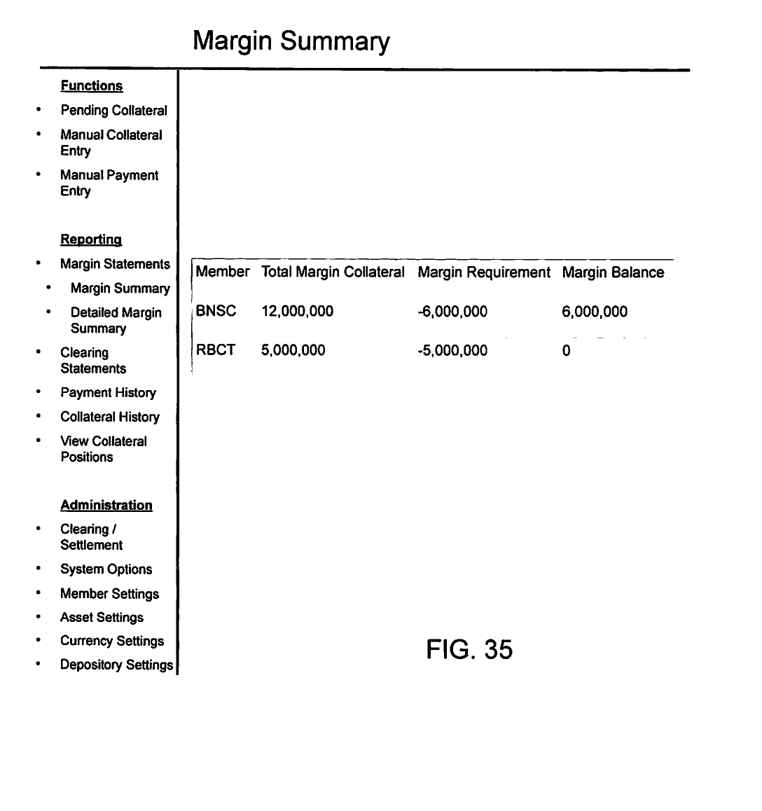

In another exemplary implementation as shown in FIGS. 35 to 43, the server 1 is configured to retrieve data from the data store 5 and generate reports for the CCCS system administrator to review. These reports may include information related to the collateral, margin, and payment transactions for one or all of the member parties.

In this exemplary implementation, the server 1 is configured to retrieve data from the data store 5 and generate margin statements for display through the client 2. These margin statements provide information regarding the margin positions of each party. In this exemplary implementation, a margin summary and detailed margin summary report can be generated.

In an exemplary implementation as shown in FIG. 35, the server 1 is configured to retrieve data from the data store 5 and generate a margin summary report for the CCCS system administrator to review. This report displays each party's total margin collateral, margin requirement, and margin balance. This allows a system administrator to quickly identify whether a party has sufficient collateral in the system to cover its payment obligations should the party default. This information can be used by the system administrator to, for example, determine the risk the party poses to the system.

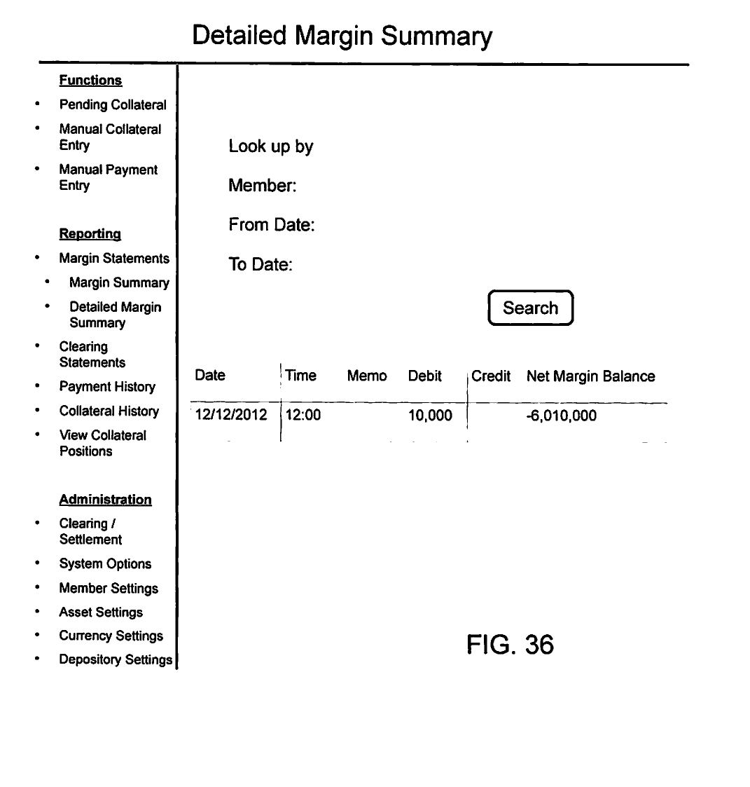

In another exemplary implementation as shown in FIG. 36, a detailed margin summary for each party can be generated by the system for review by the CCCS system admin. This report allows the system administrator to review all transactions that affected a specific party's margin over a given date range. This report includes information related to whether the transaction was a debit, a credit, and the party's net margin balance after the transaction was confirmed. This report may also show a change in margin for a party in the party's base currency, where a change in margin can be, without limitation, margin updates, collateral deposit/withdrawals, incoming/outgoing guaranteed payments, and clearing.

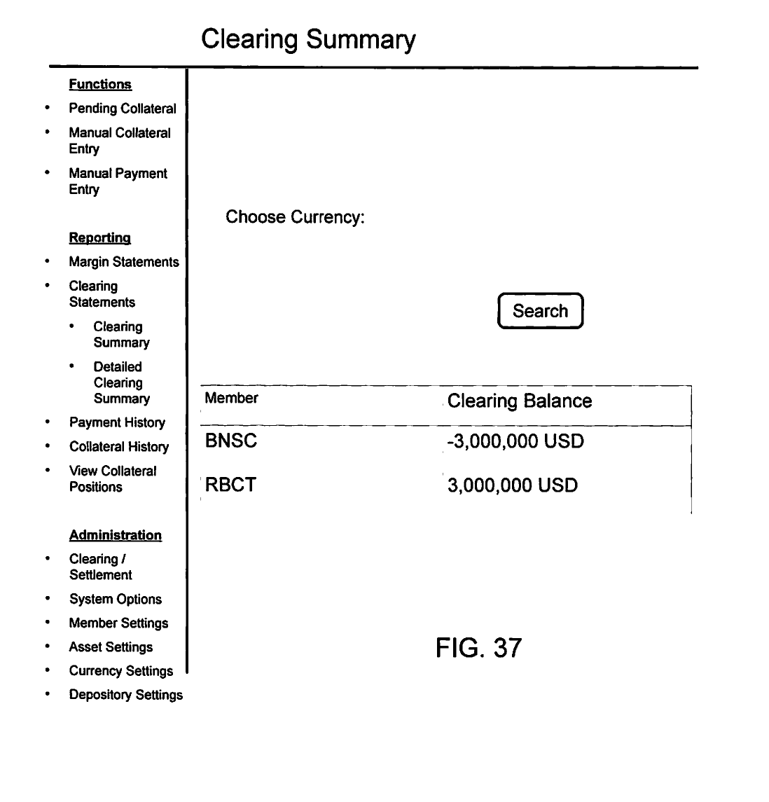

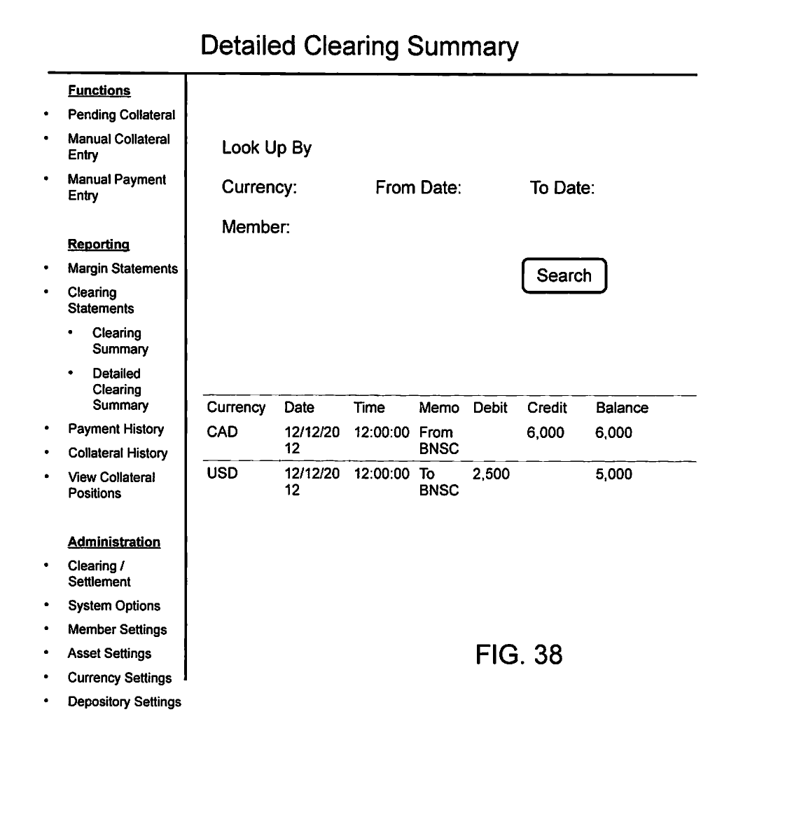

In another exemplary implementation as shown in FIGS. 37 and 38, the server 1 is configured retrieve data from the data store 5 and generate clearing reports for display through the client 2. These reports allow a CCCS system administrator to review the cleared transactions for each currency from the last clearing period. Additional clearing reports may provide information regarding clearing transactions for all parties over a date range. These reports can help the system administrator monitor and troubleshoot the system and to ensure that all transactions are clearing to a zero (0) net amount for all parties.

In an exemplary implementation as shown in FIG. 37, the CCCS is configured to generate a cash clearing summary. This report summarizes all cash clearing transactions from the previous clearing period in a specific currency for all parties. This provides a quick way for a CCCS system administrator to review the cleared transactions and ensure that the net clearing balance for all parties for that particular currency is zero (0). If the net clearing value is not zero (0) then an error has occurred and the system administrator can investigate the issue.

In another exemplary implementation as shown in FIG. 38, the system is also configured to generate a detailed cash clearing summary. This report allows CCCS system administrators to review all cleared transactions over a date range for a specified party. Information such as the date and time the transaction cleared, the currency of the transaction, the system payment id, the other party to the transaction, the debited/credited amount, and the remaining margin balance for that party can be included in the report. This information may be useful when troubleshooting the system or determining the risk to the system. This information may also be useful for research, auditing, reconciliation, accounting, and calculating metrics for future improvements to the system.

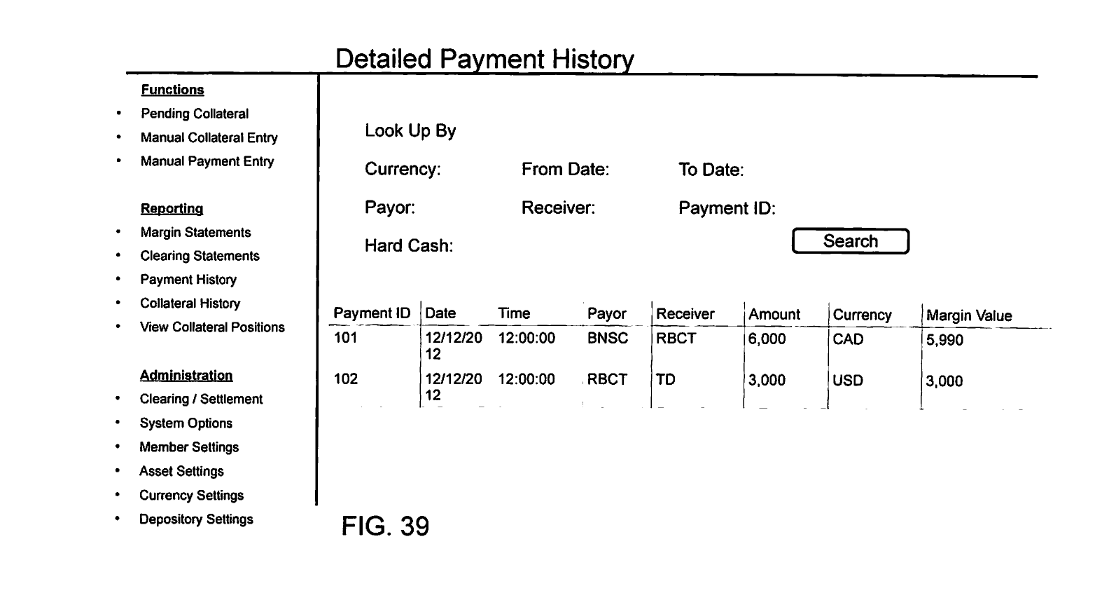

In another exemplary implementation as shown in FIG. 39, the server 1 is configured to retrieve data from the data store 5 and generate a detailed payment history report for display via the client 2. In an exemplary implementation, the CCCS system administrator can search for payment transactions using one or more criteria. These criteria can include, but are not limited to, a date range, the payment ID, the payor party, the receiving party, the currency, or whether the transaction was hard cash or soft cash. In this exemplary implementation, the generated report will contain the data provided above, as well as the relevant transaction amounts, the currency, and the effect on the party's margin balance by displaying a transaction's margin value.

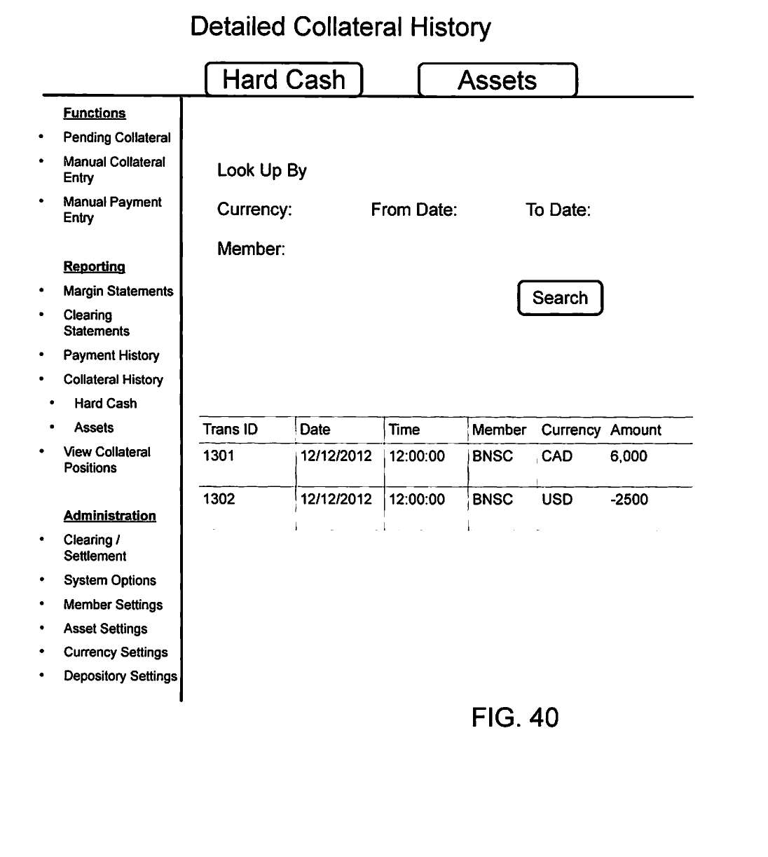

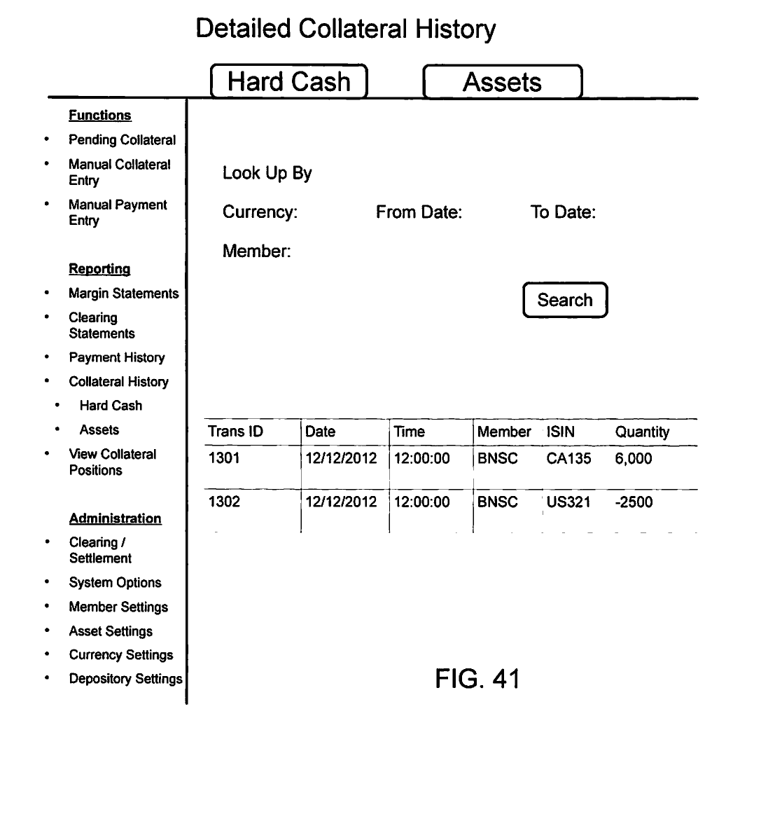

In another exemplary implementation as shown in FIGS. 40 and 41, the server 1 is configured to retrieve data from the data store 5 and generate reports for each party's collateral transactions for display via the client 2. These reports are similar to the collateral history reports that parties can generate, as was previously discussed. In other exemplary implementations, the CCCS system administrator report may generate a report that provides data for all collateral transactions for all parties at the same time.

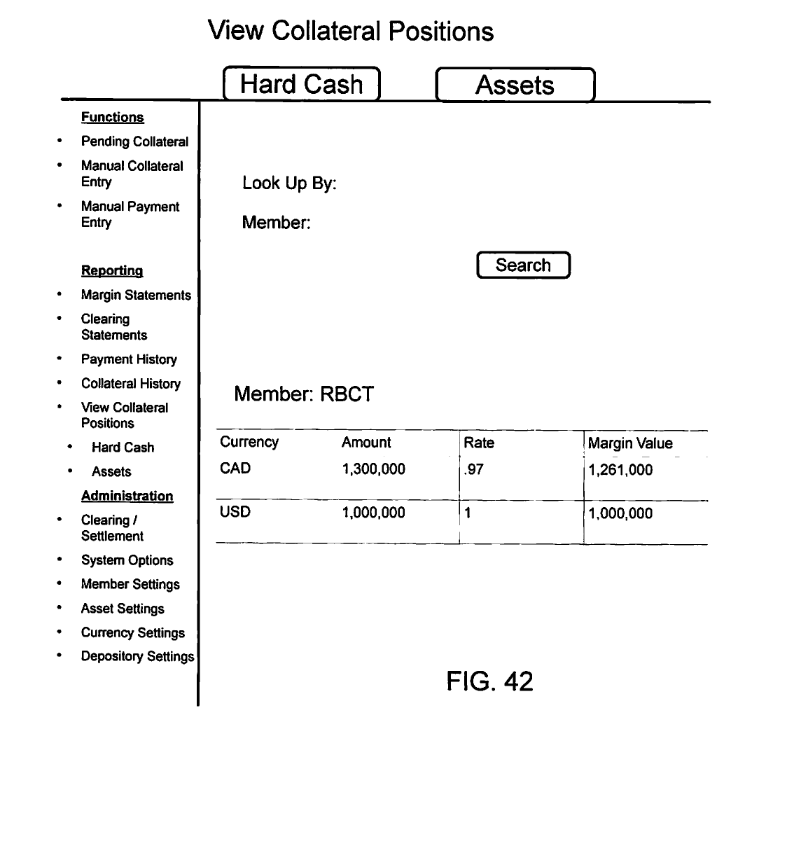

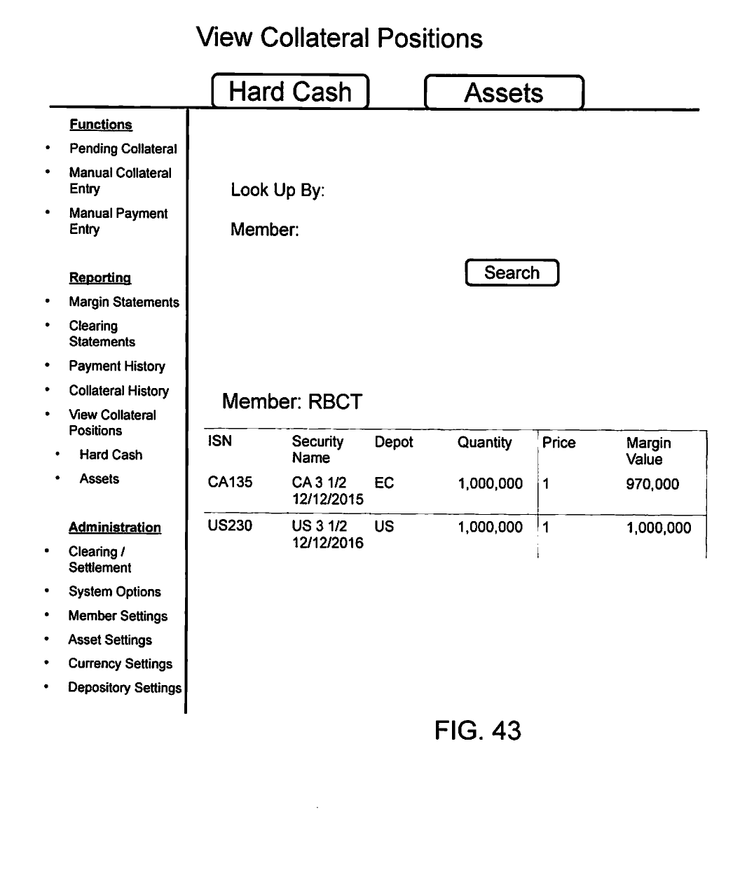

In another exemplary implementation as shown in FIGS. 42 and 43, the server 1 is configured to retrieve data from the data store 5 and generate reports for the total hard cash and asset collateral currently held by the system for display via the client 2. This allows CCCS system administrators to quickly determine the total collateral held by the CCCS for each party. This can be used to determine the overall risk and stability of the system. In the case of hard cash, the system will display the total amount of hard cash, for each party, held as collateral for each currency as shown in FIG. 42. In the case of assets, the system will display the total assets held as collateral by the system, as shown in FIG. 43.

### CCCS System Administration

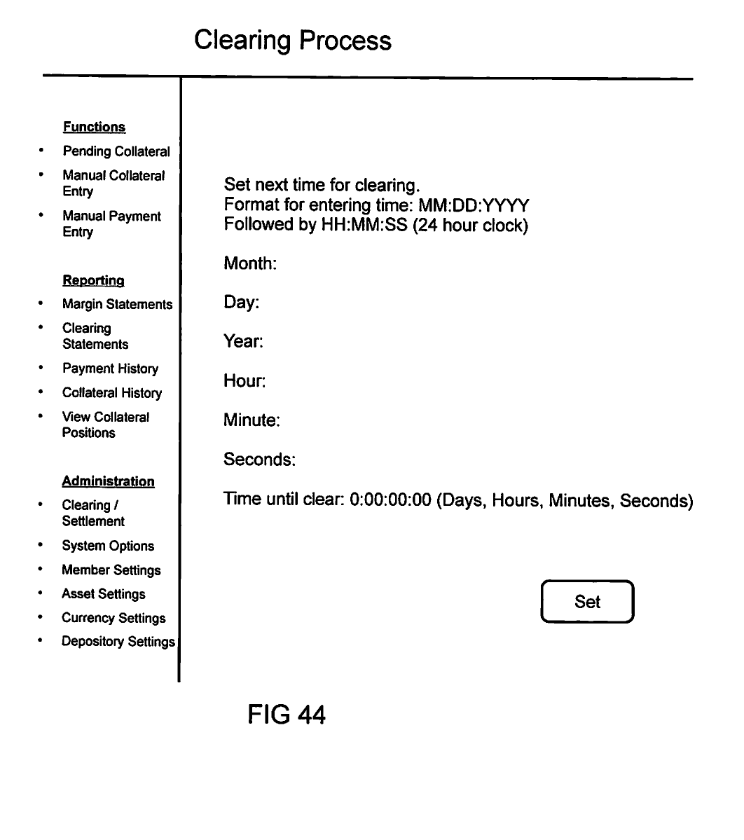

In another exemplary implementation as shown in FIGS. 44-48, the system is configured to allow CCCS system administrators to administer aspects of the CCCS. These can include adding, editing, and removing each of the following from the CCCS: parties, users, currencies, depositories, and acceptable assets. The administrative functions may also include the ability to schedule clearing windows for the CCCS.

In an exemplary implementation shown in FIG. 44, the CCCS is configured to allow a system administrator to schedule one or more clearing windows. As was previously discussed, the clearing windows commit any uncommitted payment transactions. Parties with positive or negative clearing balances when the clearing process has initiated will be notified. Those parties with positive payment balances may elect to either withdraw the cash or add the payment amount to their available collateral. Those parties with a negative balance will be required to deposit an amount equal to the negative balance. Failure to deposit the amount within a given time frame will result in liquidation of the party's collateral so that the party's negative balances in each currency can be covered by the CCCS.

In this exemplary implementation, when a clearing process of a specified window is initiated the server 1 retrieves all uncommitted payment transactions from the data store 5. In some exemplary implementations, these may be those payment transactions that are in the “accepting-pending” or “pending” state. The system 1 then generates, for each party, a clearing balance in every currency. In some exemplary implementations, the system 1 offsets all payment and receipt transactions for each party. For example, if a party has a payment transaction of $1,000 USD and a receipt transaction of $500 USD, then the net clearing balance is negative $500 USD. Parties are then notified through the client 2 if they have a positive or negative clearing balance.

In an exemplary implementation, a system administrator sets the clearing window by entering the next clearing window's date and time information. This information will be presented to the party when they use the CCCS. In some exemplary implementations, the CCCS may allow the CCCS system administrator to set the clearing window down to the second. In another exemplary implementation, a recurring series of payment windows can be scheduled in the system. For example, in another implementation a calendar may be provided that allows a system administrator to graphically input recurring clearing dates. In some exemplary implementations a countdown timer may also be provided. This countdown timer notifies the system administrator of the time remaining before the next clearing window.

In this exemplary implementation, the CCCS system administrator enters the clearing window data through the client 2. The request is then sent to the server 1 for processing. In this exemplary implementation the server 1 may validate the data from the client 2 to ensure that correct values are being entered. Once the server 1 has validated the data, the data is then stored in the data store 5. The CCCS will then begin the clearing process on the specified date and time.

In another exemplary implementation, the CCCS system administrator may be able to initiate the clearing process by clicking on a button shown through the client 2. This provides a convenient mechanism for the CCCS system administrator to initiate the clearing process immediately.

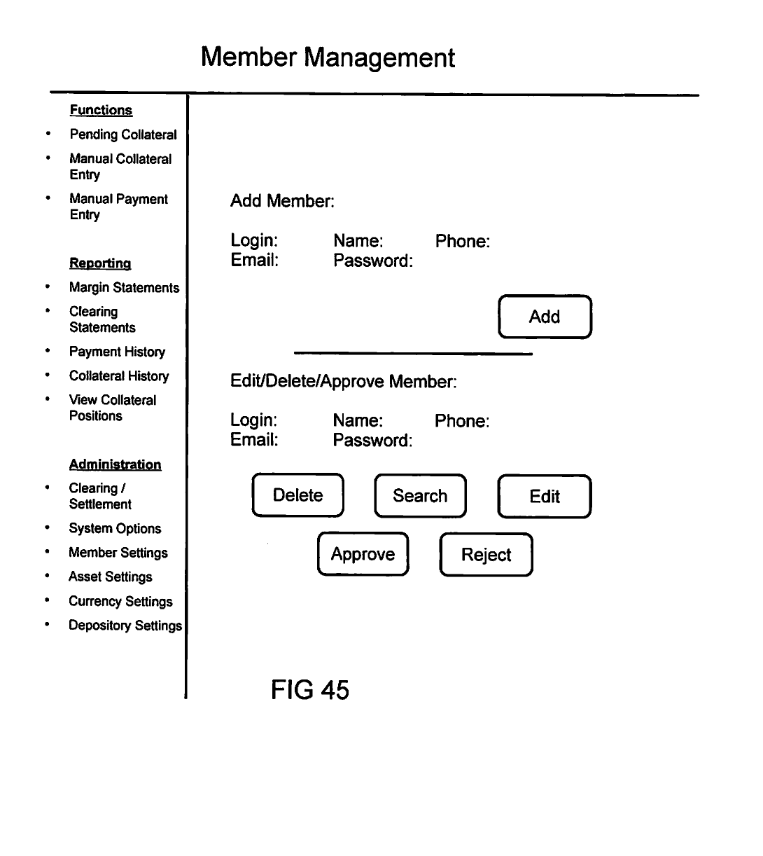

In another exemplary implementation as shown in FIG. 45, a CCCS system administrator may add, edit, or remove parties to or from the system. Parties, also known as members, of the system can include, but are not limited to, individuals, corporations, banks, non-profit organizations, countries, trading houses, clearing houses, and investment banks

In this exemplary implementation as shown in FIG. 45, a CCCS system administrator can add a member and edit a member's profile where necessary through the client 2. This information may include, but is not limited to, address and contact information, nation, role in the system (e.g., administrator, manager, trader), and name. In this exemplary implementation, the information entered at the client 2 may be validated at the server 1. This can be used, for example, to verify that email addresses or phone numbers are properly formatted. The data is then stored in the data store 5 after the data has been validated.

In some exemplary implementations, new members must be approved before the member is permitted to use the system. For example, in some circumstances it may be prudent to vet the member to ensure that the party does not introduce volatility into the system. In these circumstances, the member profile may be stored in the data store 5 as a “pending” record until the various checks have been completed. These checks can include, but are not limited to, background checks, credit checks, or identity checks. Furthermore, these checks may be performed by the CCCS or by an external third party. For instance, in an exemplary implementation the CCCS may be in communication via a global secured network 3 with a third-party validation system.

In another exemplary implementation, the server 1 is configured to retrieve from and the data store 5 and generate a list of all pending parties of the CCCS. In another exemplary implementation, the CCCS system administrator edits the pending party's status from pending to member through the member management screen as displayed through the client 2, as shown in FIG. 45. In yet another exemplary implementation, the system administrator may also suspend or remove clearing members or their users from the CCCS.

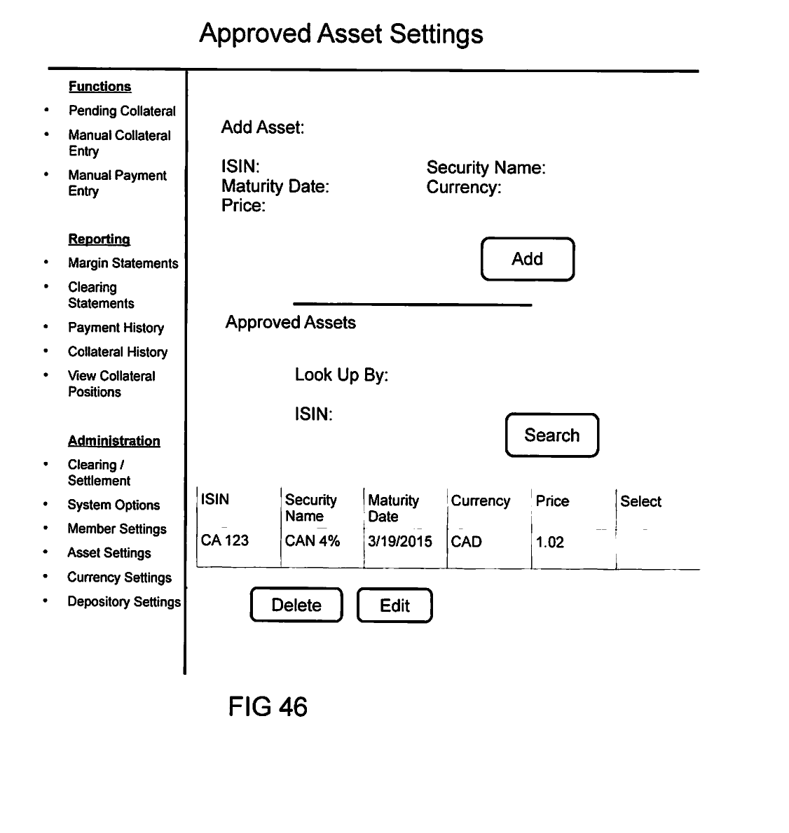

In another exemplary implementation as shown in FIG. 46, a CCCS system administrator can view, edit, and add an approved asset. An approved asset is one that can be used as collateral in the CCCS. In principle, any non-cash asset can be used as collateral. As was discussed earlier, however, stable and liquid assets are generally preferred over illiquid assets. Examples of liquid and stable assets include, but are not limited to, corporate and national bonds, government debt, and precious metals.

In another exemplary implementation, the CCCS allows assets that are highly rated by a third party rating agency to be used as collateral. For instance, in some exemplary implementations, the CCCS may use ratings lists from agencies such as Moodys or Standard & Poors to determine a list of approved assets.

In this exemplary implementation as shown in FIG. 46, the asset's unique identifier (ISIN), the name of the security, the maturity date, the currency, and the price can all be entered and edited by the CCCS system administrator through the client 2. In another exemplary implementation, the key asset data such as the price or maturity date can be obtained from a trusted and secured data source that is connected to the server 1 through the global secure network 3. In some exemplary implementations this data may be validated by the server 1. This validation can be used to ensure that the collected data is formatted correctly. Once the data has been validated, the server 1 then stores the data in the data store 5.

In another exemplary implementation as shown in FIG. 46, the server 1 is configured to retrieve from the data store 5 and generate a list of approved assets. The CCCS system administrator can review the retrieved data for correctness, edit the data, or delete the approved asset from the system. When an approved asset is updated or deleted the server 1 updates the data store 5 accordingly.

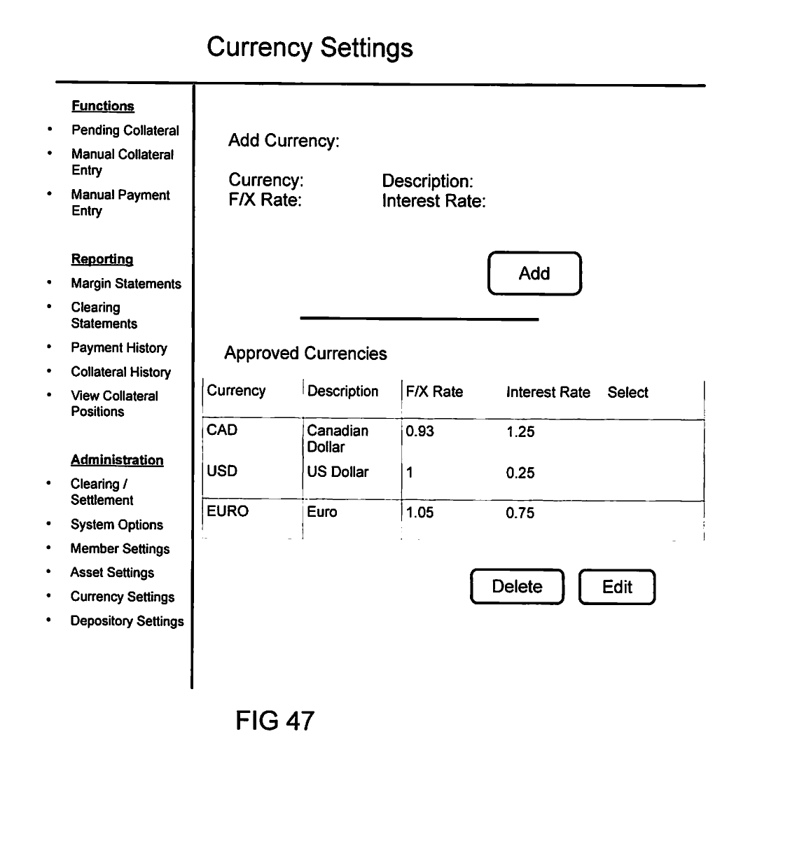

Similar to the asset settings above, in another exemplary implementation as shown in FIG. 47, a CCCS system administrator can to view, edit, delete, and add a currency approved for use in the CCCS. In principle, any currency could be used in the system. In use, however, it is expected that only the world's most commonly traded currencies would be used in this system. These currencies can include, but are not limited to, the American (US), Canadian, and Australian Dollar, the Euro, the Japanese Yen, the Chinese Yuan, the British Pound, and the Swiss Franc. In some exemplary implementations the system administrator can manually update the foreign exchange rate relative to a base currency. In this exemplary implementation, the US dollar is set as the system base currency and all other currencies have an exchange rate relative to the US dollar. In other exemplary implementations the server 1 can obtain key currency data, such as exchange rate, automatically from a trusted and secured data source connected to the server 1 through the global secured network 3.

Similar to the currency settings above, in another exemplary implementation a CCCS system administrator may view, edit, delete, and add an interest rate. In this exemplary implementation the interest rates is applied to any positive or negative margin balances. In some exemplary implementations, the interest rate is set by the CCCS system administrator to account for regulatory, risk, and legal restrictions and can be any arbitrary number, within legal limits. In other exemplary implementations, the interest rate can be agreed upon by members of the CCCS.

In yet another exemplary implementation, the interest rates can also be bilaterally agreed upon by payor and receiver parties. In this exemplary implementation, the bilaterally agreed upon interest rate is stored in the data store. This interest rate is then applied to the payment transaction of the payor party and the receipt transaction of the receiver party such that the interest amounts applied net to zero (0). In another exemplary implementation, the CCCS may levy a fee for the interest calculation and collection and apply it to the payor's balance, the receiver's balance, or both.

In other exemplary implementations, the interest rate is based on a commonly accepted interest rate such as the US or Canadian inter-bank loan rate. In the exemplary implementations provided above, the CCCS system administrator may manually enter the interest rate through the client 2. The server 1 may then validate the data entered through the client 2. Once validated, the interest rate is then stored in the data store 5. In another exemplary implementation, the interest rate is obtained automatically from a trusted and secured data store connected to the server 1 through the global secured network 3.

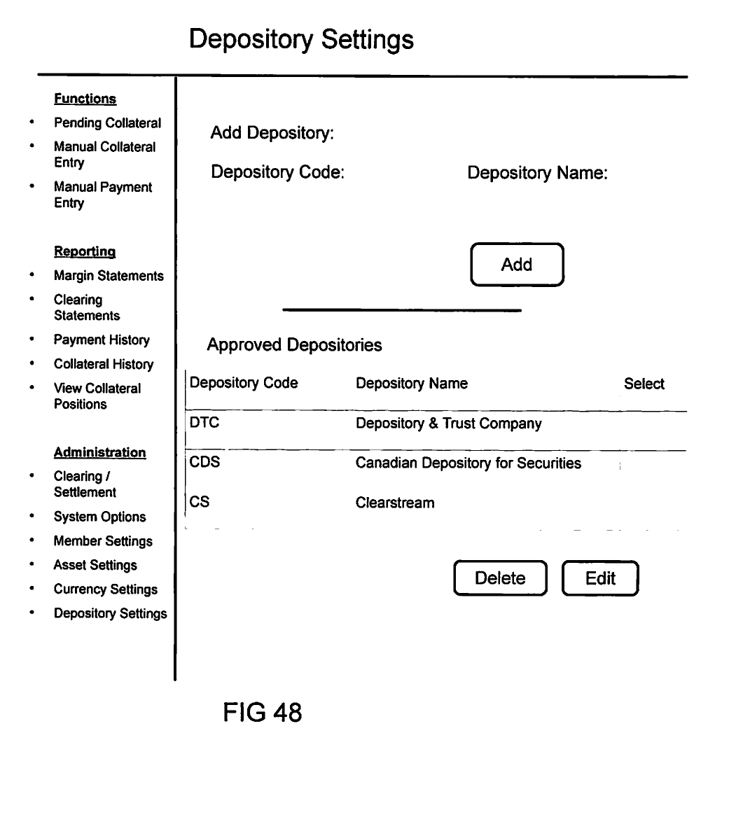

In another exemplary implementation as shown in FIG. 48, a CCCS system administrator can add, delete, and update depository information. As was previously discussed, a depository holds and transfers securities on behalf of parties and institutions. In this exemplary implementation, the system administrator can manually enter the information of approved depositories through the client 2. This data may be validated by the server 1 to ensure that the data, for example, complies with formatting rules. The server 1 then stores the data in the data store 5. In other exemplary implementations, the depository information may be obtained from a trusted and secured data source connected to the server 1 through a global secured network 3.

In this exemplary implementation, only depositories approved by the system can be used to hold or transfer assets as collateral on behalf of the system. In another exemplary implementation, any attempts by parties to deposit or transfer assets using an unapproved depository will not be recognized as collateral by the system.

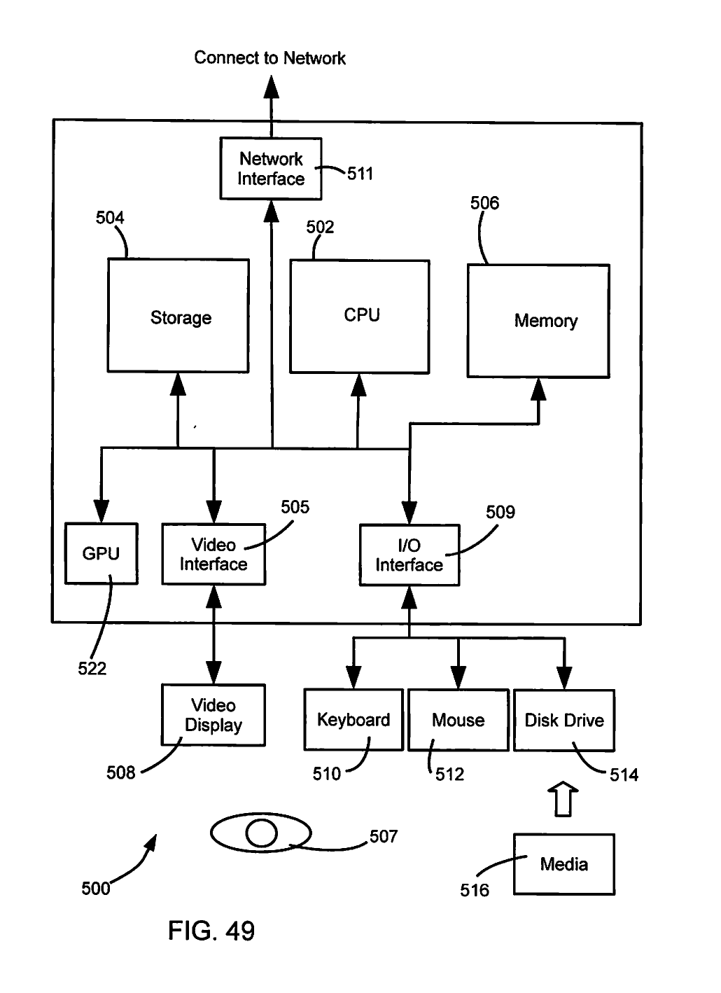

The present system and method may be practiced in various implementations. A suitably configured computer device, and associated communications networks, devices, software and firmware may provide a platform for enabling one or more implementations as described above. By way of example, FIG. 49 shows a generic computer device 500 that may include a central processing unit (CPU) 502 connected to a storage unit 504 and to a random access memory 506. The CPU 502 may process an operating system, application program, and data. The operating system, application program, and data may be stored in storage unit 504 and loaded into memory 506, as may be required. Computer device 500 may further include a graphics processing unit (GPU) 522 which is operatively connected to CPU 502 and to memory 506 to offload intensive image processing calculations from CPU 502 and run the calculations in parallel with CPU 502. An operator 507 may interact with the computer device 500 using a video display 508 connected by a video interface 505, and various input/output devices such as a keyboard 510, mouse 512, and disc drive or solid state drive 514 connected by an I/O interface 509. In known manner, the mouse 512 may be configured to control movement of a cursor in the video display 508, and to operate various GUI controls appearing in the video display 508 with a mouse button. The disk drive or solid state drive 514 may be configured to accept computer readable media 516. The computer device 500 may form part of a network via a network interface 511, allowing the computer device 500 to communicate with other suitably configured data processing systems (not shown).

In further aspects, the disclosure provides systems, devices, methods, and computer programming products, including non-transient machine-readable instruction sets, for use in implementing such methods and enabling the functionality described previously.

Although the disclosure has been described and illustrated in exemplary forms with a certain degree of particularity, the description and illustrations have been made by way of example only.

Numerous changes in the details of construction and combination and arrangement of parts and steps may be made. Accordingly, such changes are intended to be included in the disclosure, the scope of which is defined by the claims.

What is claimed is:

1. A computer implemented method for fulfilling obligations between a plurality of parties over a computer network, the method comprising:
on a client controlled by a first party of the plurality of parties:
initiating a payment transaction request, in a single currency, to a second party of the plurality of parties;
on a server controlled by an independent third party to the plurality of parties:
accepting payment transaction requests from the client machine;
recording the payment transaction as an uncleared outgoing payment transaction for the first party and an uncleared incoming payment transaction for the second party in a data store; and
clearing, at a time determined by the server, all uncleared payment transactions from the plurality of parties.

2. The computer implemented method of claim 1 the step of accepting further comprising:
converting the first party's payment transaction currency to the first party's base currency;
determining whether the first party has sufficient margin balance to cover the payment transaction request by determining whether the payment transaction request will cause the first party's margin balance to fall below a threshold value
wherein each of the plurality of parties has a margin balance associated with the party, in a base currency, the margin balance determined by:
adding a total collateral value of the party with the total incoming payment transaction value for the party in all currencies, converted to the party's base currency; and
subtracting the total outgoing payment transaction value for the party in all currencies, converted to the party's base currency.

3. The computer implemented method of claim 2, the step of clearing further comprising:
offsetting each party's incoming and outgoing payment transactions for each currency so that each party has a net positive or net negative margin balance for each currency;
wherein
parties having a net negative margin balance are required to deposit the net negative margin balance for each currency before a predetermined time frame set by the server; and
the net of all uncleared incoming and uncleared outgoing payment transactions for all parties, is zero (0).

4. The computer implemented method of claim 3, wherein the party's collateral is liquidated to cover the net negative balance if, after clearing, the party having a net negative balance fails to deposit the amount for each currency before the predetermined time frame expires.

5. The computer implemented method of claim 4, the total collateral value comprising the sum of the values of a party's:
hard cash;
soft cash; and
the value of one or more approved securities, the one or more approved securities comprising at least one of stocks, bonds, and government issued debt.

6. The computer implemented method of claim 5, the step of accepting payment transaction requests from the plurality of parties further comprising:
applying a risk management filter to the payment transaction request, the risk management filter comprising the application at least one of:
collateral limits;
collateral haircuts;
currency limits;
currency haircuts; and
payment transaction haircuts
to a party's margin value, margin balance, or collateral value.

7. The computer implemented method of claim 6, the step of clearing further comprising:
notifying a party, through the client, of a negative clearing balance.

8. The computer implemented method of claim 7, the method further comprising:
applying interest to the party's margin balance.

9. The computer implemented method of claim 8, the clearing time set by the server being at least one of:
hourly;
daily;
weekly;
bi-weekly;
bi-monthly;
bi-yearly;
yearly; or
at the discretion of the third party.

10. The computer implemented method of claim 9, the computer network comprising a plurality of clients and servers connected over the Internet using the hypertext transfer protocol secure (HTTPS).

11. The computer implemented method of claim 9, the computer network comprising a virtual private network (VPN) over the Internet.

12. A system for fulfilling obligations between a plurality of parties over a computer network, the system comprising:
a data store configured to store transactional, client, and system data;
at least one server configured to:
process payment transactions in one or more currencies from one or more clients;
store the payment transactions in the data store as incoming and outgoing pending payment transactions; and
clear the transactions at a set time using transaction data stored in the data store by offsetting each party's incoming and outgoing payment transactions for each currency so that each party has a net positive or net negative balance for each currency; and
the one or more clients configured to:
initiate payment transaction requests.

13. The system of claim 12, the server further configured to:
apply risk management filters to the payment transaction;
provide status reports to clients on demand;
notify clients of a deposit requirement when the client has a net negative balance; and
liquidate at least a portion of the client's collateral to cover the deposit requirement if the deposit requirement is not completed before a timer expires.

14. The system of claim 13, the client further configured to request status reports from the server.

15. The system of claim 14, the one or more servers further configured to:
calculate interest on one or all of a party's margin balance, margin value, and collateral value; and
store the interest adjusted value in the data store.

16. The system of claim 15, the risk management filters comprising the application of at least one of:
collateral limits;
collateral haircuts;
currency limits;
currency haircuts; and
payment transaction haircuts to a party's margin value, margin balance, or collateral value.

17. The system of claim 16, the server further comprising an application programming interface for allowing third-party applications to access the server.

18. The system of claim 17, the system further comprising at least one administration terminal connected to the global computer network;
the at least one administration terminal configured allow an administrator to administer the system.

19. The system of claim 18, wherein the client, server, and administration terminal are connected through the Internet using one of hypertext transfer protocol secure (HTTPS) or a virtual private network (VPN).

20. The system of claim 19, wherein the server comprises a web server and is at least one of one or more virtual servers on the internet, or a computer.

21. The system of claim 20, wherein the data store is a database.

22. The system of claim 21, wherein the client and administration terminals are computers comprising a web browser.

23. A computer implemented method for fulfilling cross-currency payment obligations between a plurality of parties over a computer network, the method comprising:
on a client controlled by a first party of the plurality of parties:
initiating a cross-currency payment transaction request, in a single currency, to a second party of the plurality of parties;
on a server controlled by an independent third party to the plurality of parties:
accepting payment transaction requests from the client machine;
recording the payment transaction as an uncleared outgoing payment transaction for the first party and an uncleared incoming payment transaction for the second party in a data store; and
clearing, at a time determined by the server, all uncleared payment transactions from the plurality of parties.

24. The computer implemented method of claim 23, the step of accepting further comprising:
converting the first party's payment transaction currency to the first party's base currency;
determining whether the first party has sufficient margin balance to cover the payment transaction request by determining whether the payment transaction request will cause the first party's margin balance to fall below a threshold value;
wherein each of the plurality of parties has a margin balance associated with the party, in a base currency, the margin balance determined by:
adding a total collateral value of the party with the total incoming payment transaction value for the party in all currencies, converted to the party's base currency; and
subtracting the total outgoing payment transaction value for the party in all currencies, converted to the party's base currency.

25. The computer implemented method of claim 24, the step of clearing further comprising:
offsetting each party's incoming and outgoing payment transactions for each currency so that each party has a net positive or net negative margin balance for each currency;
wherein
parties having a net negative margin balance are required to deposit the net negative margin balance for each currency before a predetermined time frame set by the server; and
the net of all uncleared incoming and uncleared outgoing payment transactions for all parties, is zero (0).
